(19) United States
(12) Patent Application Publication
(10) Pub. No.: US 2026/0269646 A1
(43) Pub. Date: Sep. 10, 2026

(54) PROCESSING SYSTEM AND PROCESSING METHOD FOR CONGESTION RESOLUTION, DISTRIBUTION SYSTEM CONTROL SYSTEM, AND SYSTEM COMPRISING A DISTRIBUTION GRID

(71) Applicant: HITACHI ENERGY GERMANY AG, Mannheim (DE)

(72) Inventors: Giancarlo DALLE AVE, Toronto (CA); Milos SUBASIC, Mannheim (DE); Susanne SCHMITT, Heidelberg (DE); Iiro HARJUNKOSKI, Espoo (FI); Peter NOGLIK, Edingen-Neckarhausen (DE)

(21) Appl. No.: 19/166,321

(22) PCT Filed: Mar. 31, 2023
(86) PCT No.: PCT/EP2023/058450

§ 371 Date: Sep. 17, 2025

(51) Int. Cl. H02J 13/12; H02J 3/12; H02J 103/35

(52) U.S. Cl. CPC H02J 13/12; H02J 3/12; H02J 2103/35

(57) ABSTRACT

Processing methods and processing systems are provided which are operative to determine operations to be taken to resolve a congestion. The processing system is operative to perform a congestion identification for at least a part of a power distribution system and to perform a congestion resolution processing, based on power transfer distribution factors (PTDFs).

### TECHNICAL FIELD

Embodiments of the invention relate to systems and methods to perform processing operations related to a distribution grid. Embodiments of the invention relate in particular to systems and methods useful for addressing congestions in a distribution grid.

### BACKGROUND

Power grids are important infrastructure components. Power grids include a transmission grid and one or several distribution grids.

The increasing number of distributed energy resources (DERs) and/or loads (e.g., electric vehicle (EV) charging stations) on the distribution level causes several problems in distribution grids including overloads (congestions) and voltage range deviations, which may lead to asset damage and potential blackouts.

To mitigate or avoid such potentially damaging situations, generators and/or loads can be curtailed. Traditionally, such curtailment is performed based on human operator experience. This may result in a curtailment that is associated with a large waste of renewable energy, which goes against clean-energy policies. Such techniques may also be prone to having shortcomings due to potential human operator errors.

A curtailment determined by a human operator may also suffer shortcomings when future scenarios change, e.g. due to changing weather conditions, which may make it challenging for the human operator to take appropriate counter-actions to mitigate or avoid a congestion in a distribution grid.

### SUMMARY

It is an objective of the invention to provide methods, devices, and/or systems that provide enhanced techniques of resolving congestions. In particular an objective of the invention is to provide methods, devices, and/or systems operative to perform congestion resolution processing in an efficient manner. It is also an object of the invention to provide methods, devices, and/or systems that can determine which generators and/or loads are to be curtailed to resolve a congestion, thereby assisting in distribution system control. It is an optional objective of the invention to provide methods, devices, and/or systems operative to determine the generators and/or loads to be curtailed in a fair and unbiased manner, based on objective criteria.

According to exemplary embodiments, methods and systems as recited in the claims are provided. The dependent claims define preferred or advantageous embodiments.

According to an aspect of the invention, a processing system is provided. The processing system comprises at least one processing circuit operative to perform a congestion identification to identify a congestion in a section of a distribution grid of an electric power grid; perform congestion resolution processing to mitigate or eliminate the congestion, the congestion resolution processing comprising a determination of at least one element that is to be controlled to mitigate or eliminate the identified congestion, the at least one element comprising at least one generator and/or at least one load, the at least one processing circuit being operative to determine the at least one element based on power transfer distribution factors (PTDFs) determined for at least the section of the power grid; and generate output that is provided via at least one interface of the processing system based on the congestion resolution processing.

Various effects and advantages are attained by the processing system. The processing system can assist a distribution system operator (DSO) in the complex task of determining one or several elements that are to be adjusted, e.g., by generator and/or load curtailment, for eliminating a congestion. The congestion may be a currently existing or a predicted future congestion. By using the PTDFs, the element(s) that are to be adjusted to eliminate the congestion can be identified efficiently, using knowledge of the power transfer between different parts of the distribution grid provided by the PTDFs. Thus, determining a sequence in which generators and/or loads are to be curtailed and/or determining curtailment amounts may be performed efficiently. This allows actions, such as curtailment of generators and/or loads, to be taken swiftly and in an at least partially, optionally fully, automated manner.

The PTDFs are indicative of a sensitivity of the power at the location of the congestion to changes made in various locations of the distribution grid. Thus, the processing system implements a sensitivity-based adjustment of settings (such as setpoints) of one or more generators and/or one or more loads.

The congestion identification and congestion resolution processing may use operating conditions of the distribution grid as input. The operating conditions may comprise setpoints for generators. The operating conditions may comprise setpoints for loads. The operating conditions may comprise measurements or forecasts for load powers. The operating conditions may determine generator and load powers for all generators and loads, either for a current time, a time in the past (e.g., when analyzing past situations), or a time in the future (e.g., when determining suitable curtailment actions in a predictive manner). When the processing system is operated for forecasting curtailment actions that are suitable for operating conditions in the future, the operating conditions may be based inter alia on weather forecast data or other predictive information that affects power generation and/or load powers.

The congestion resolution processing may comprise a determination of an updated setting for each element of the at least one element based on the PTDFs. The at least one processing circuit may be operative to generate the output based on the updated setting.

Thereby, the output may indicate the updated setting, such as an updated setpoint, determined by the processing system as being suitable for resolving the congestion. The output may be used by a control system to which the processing system is coupled or of which the processing system may be a part, to automatically adjust the current or future operation based on the determined updated setting. Thus, the output may be operative to cause a change in generator and/or load operation.

The updated setting may comprise an updated setpoint for the at least one element.

Thereby, the output may indicate the updated setpoint, determined by the processing system as being suitable for resolving the congestion. The determination of the updated setpoint is performed automatically by the processing system.

The at least one processing circuit may be operative such that the updated setting may comprise a curtailment of the determined at least one generator and/or at least one load.

Thereby, curtailment actions and an amount by which power is to be curtailed are determined automatically by the processing system.

The at least one processing circuit may be operative to determine the curtailment based on the PTDFs.

Thereby, the suitability of various generators and/or loads of the distribution grid for causing the congestion to be resolved may be taken into account when curtailing one or more generator(s) and/or load(s).

The at least one processing circuit may be operative to determine the curtailment based on a number of elements to be controlled to mitigate or eliminate the identified congestion.

Thereby, the processing system may determine the curtailment sequentially for one generator and/or load at a time, making the determination particularly efficient. Thus, a greedy redispatch may be performed, for example.

The at least one processing circuit may be operative to determine the curtailment independently of a number of elements to be controlled to mitigate or eliminate the identified congestion.

Thereby, the processing system may distribute the corrective action that is required over several generators and/or loads, resulting in a fairer curtailment action. For illustration, a proportional redispatch may be performed.

The PTDFs may be complex-valued.

Thereby, better congestion resolution results are obtained. Surprisingly, the congestion resolution results obtained when determining the PTDFs as complex-values PTDFs and then using the real part (i.e., the active part) thereof for determining the element(s) to be curtailed and the respective curtailment amounts outperform the results that would be obtained if only real-valued PTDFs were determined at the outset.

The at least one processing circuit may be operative to perform the congestion resolution processing based on a real part (i.e., the active part) of the PTDFs.

Thereby, better congestion resolution results are obtained. Surprisingly, the congestion resolution results obtained when determining the PTDFs as complex-values PTDFs and then using the real part (i.e., the active part) thereof for determining the element(s) to be curtailed and the respective curtailment amounts outperform the results that would be obtained if only real-valued PTDFs were determined at the outset.

The at least one processing circuit may be operative to perform the congestion resolution processing independently of the imaginary part of the PTDFs.

Thereby, better congestion resolution results are obtained. Surprisingly, the congestion resolution results obtained when determining the PTDFs as complex-values PTDFs and then using the real part (i.e., the active part) thereof for determining the element(s) to be curtailed and the respective curtailment amounts outperform the results that would be obtained if only real-valued PTDFs were determined at the outset.

The PTDFs comprise alternating current (ac) PTDFs.

Thereby, better congestion resolution results are obtained. Surprisingly, the congestion resolution results obtained when determining the PTDFs as ac-PTDFs and then using the real part (i.e., the active part) thereof for determining the element(s) to be curtailed and the respective curtailment amounts outperform the results that would be obtained if only real-valued PTDFs were determined at the outset.

The at least one processing circuit may be operative to perform a PTDF determination to determine the PTDFs.

Thereby, the determination of the PTDFs may be implemented in the processing system and may be repeated as the need arises, e.g., in response to a temporary change in distribution grid topology.

The at least one processing circuit may be operative such that the PTDF determination comprises a power flow computation.

Thereby, processing techniques (namely power flow computation) and the information required therefor (such as admittance and Jacobian matrices) may be used also in the process of determining the PTDFs.

The at least one processing circuit may be operative to determine derivatives of power with respect to voltage magnitude for PV and PQ buses of the section of the distribution grid, to determine some of the PTDFs (such as the PTDFs of the PV buses and the real parts (i.e., the active part) of the PTDFs for the PQ buses). The at least one processing circuit may be operative to determine derivatives of power with respect to phase angle for PQ buses of the section of the distribution grid, to determine some of the PTDFs (such as the imaginary parts of the PTDFs for the PQ buses). This allows the PTDFs to be determined without requiring an inversion of a sensitivity matrix.

Thereby, the PTDFs may be determined efficiently and reliably. Congestion resolution can be performed in an efficient manner.

The at least one processing circuit may be operative to determine derivatives of power with respect to voltage magnitude for PV and PQ buses of the section of the distribution grid to determine matrix elements of a sensitivity matrix, and to then multiply a real part of the sensitivity matrix with incremental voltage changes to determine at least some of the PTDFs.

Thereby, the PTDFs may be determined efficiently and reliably. Congestion resolution can be performed in an efficient manner.

The at least one processing circuit may be operative to determine the PTDFs without using an inversion of the sensitivity matrix.

Thereby, the PTDFs may be determined efficiently and reliably. Congestion resolution can be performed in an efficient manner.

The at least one processing circuit may be operative to determine the PTDFs such that each PTDF quantifies a sensitivity of a line power of the distribution grid on a power injection of a PV or PQ bus of the distribution grid.

Thereby, quantities are determined which are particularly suitable for identifying which generators and/or loads are to be curtailed for resolving a congestion at a line or a transformer.

The at least one processing circuit may be operative to determine the PTDFs as matrix elements of a PTDF matrix, wherein rows of the PTDF matrix are associated with lines of the distribution grid (or a section thereof) and columns of the PTDF matrix are associated with buses of the distribution grid (or the section thereof) (or vice versa, with the rows being associated with buses and the columns being associated with lines). The PTDF matrix may have a number of rows that is equal to a number of lines in the distribution grid (or a section thereof) and a number of columns that is equal to a number of PV buses plus twice a number of PQ buses in the distribution grid (or a section thereof); or, alternatively, a number of columns that is equal to a number of lines in the distribution grid (or a section thereof) and a number of rows that is equal to a number of PV buses plus twice a number of PQ buses in the distribution grid (or a section thereof).

Thereby, the PTDFs may be determined using techniques and routines that are well established in the field of transmission systems and that are available to the skilled person.

The at least one processing circuit may be operative to apply scaling factors to admittances used in the power flow computation when determining the PTDFs. The at least one processing circuit may be operative to perform a scaling of admittances when determining the PTDFs to account for the fact that admittances in a distribution grid are typically less than admittances in a transmission grid. The scaling may be performed prior to performing power flow and PTDF calculations.

Thereby, the PTDFs may be determined using techniques and routines that are well established in the field of transmission systems and that are available to the skilled person.

The at least one processing circuit may be operative to perform the congestion resolution processing based on both the PTDFs and a merit order relating to loads and/or generators.

Thereby, the merit order may be taken into consideration by the at least one processing circuit when determining curtailment of generators and/or loads.

The processing system may further comprise a human machine interface (HMI). The processing system may be operative to enable the user to specify a merit order relating to loads and/or generators of the distribution grid.

Thereby, the merit order may be specified by the distribution system operator at the HMI of the processing system.

The processing system may be operative to retrieve the merit order via a data interface.

Thereby, the processing system can retrieve the merit order from a control system or a storage system in which it is stored.

The at least one processing circuit may be operative to determine the at least one element based on the merit order.

Thereby, the merit order may be taken into consideration by the processing system when determining which generators and/or loads are to be curtailed.

The at least one processing circuit may be operative to determine the updated setting based on the merit order.

Thereby, the merit order may be taken into consideration by the processing system when determining a curtailment amount for the generators and/or loads to be curtailed.

The at least one processing circuit may be operative to perform a ranking of generators and/or loads of the section based on the PTDFs and the merit order, and to perform the congestion resolution processing based on the ranking.

Thereby, the merit order and the sensitivity of lines and/or transformer loads to changes in generator and/or load power level as reflected by the PTDFs may be used in combination to perform the congestion resolution processing.

The congestion resolution processing may be performed separately for each of several sections of the distribution grid.

Thereby, stability of the processing is increased and the processing can be performed sufficiently quickly to react to changing conditions (such as changing weather conditions and/or changing load powers).

The at least one processing circuit may be operative to automatically determine a plurality of sections of the distribution grid based on a distribution grid topology, and to perform the congestion identification and the congestion resolution processing for each section of the plurality of sections.

Thereby, the sections may be identified automatically. The processing system may retrieve the distribution grid topology from a system configuration file or other configuration description of the distribution grid. The distribution grid topology may be defined by at least a single line diagram of the distribution grid. The processing system may retrieve the distribution grid topology from a database, using a database connection.

The at least one processing circuit may be operative to perform the congestion identification and the congestion resolution processing for the plurality of sections independently for each of the plurality of sections.

Thereby, stability of the processing is increased. The processing can be performed sufficiently quickly to react to changing conditions (such as changing weather conditions and/or changing load powers).

The at least one processing circuit may be operative to identify, based on the distribution grid topology, radial feeder sections and loop sections, and wherein the at least one processing circuit may be operative to determine the plurality of sections as a union of the radial feeder sections and the loop sections.

Thereby, sections suitable for separately performing congestion identification and resolution processing may be determined automatically by the processing system.

The at least one processing circuit may be operative to perform a verification to confirm that the congestion resolution processing mitigates or eliminates the identified congestion before generating the output.

Thereby, reliability of the congestion resolution is enhanced.

The verification may comprise updating the PTDFs based on the congestion resolution processing.

Thereby, updated PTDFs are available for further use, e.g., for performing a further congestion resolution processing and/or for determining that the updated settings resolve the congestion.

The verification may comprise performing a further power flow computation.

Thereby, reliability of the congestion resolution is enhanced in particular when using redispatch schemes which do not lend themselves to verifying that the congestion is resolved based on PTDFs alone.

The output may comprise an output for use by a distribution system operator (DSO).

Thereby, the results of the congestion resolution processing (such as updated setpoints for generators and/or loads) may be provided to a control component of a distribution system control system, an energy management system (EMS), and/or a power management system (PMS), to thereby influence operation of the distribution grid.

The output may comprise a command operative to adjust setpoints of the determined at least one generator and/or at least one load.

Thereby, the results of the congestion resolution processing (such as updated setpoints for generators and/or loads) can affect control operations acting on the distribution grid, e.g., by curtailing generators and/or loads.

The at least one processing circuit may be operative such that the congestion resolution processing determines one or several updated setpoints for generators and/or loads for presently existing operating conditions (i.e., for operating conditions that prevail at the time of the processing). The presently existing operating conditions may comprise presently existing setpoints of all generators of the section of the distribution grid, and information on presently existing load powers of all loads of the section of the distribution grid. The information on presently existing load power may comprise measurements obtained under the presently existing operating conditions and/or presently existing setpoints for loads. The at least one processing circuit may be operative to identify a presently existing congestion, to determine one or several updated setpoint(s) for one or several generator(s) and/or one or several load(s) that resolve the congestion, and to generate the output based on the one or several updated setpoint(s) to cause the presently existing congestion to be resolved (e.g., by changing the operation of the generator(s) and/or load(s)). The processing system or a distribution system control system that comprises or is coupled to the processing system may cause the generator(s) and/or loads to operate in accordance with the one or several updated setpoint(s).

Thereby, the processing system is operative to determine settings that resolve a presently existing congestion.

Alternatively or additionally, the at least one processing circuit may be operative such that the congestion resolution processing determines one or several updated setpoints for generators and/or loads for future operating conditions (i.e., for operating conditions that prevail at the time of the processing). The future operating conditions may comprise future setpoints of all generators of the section of the distribution grid, and information on future load powers of all loads of the section of the distribution grid. The information on future load power may comprise measurements obtained under the future operating conditions and/or future setpoints for loads. The at least one processing circuit may be operative to identify a future congestion, to determine one or several updated setpoint(s) for one or several generator(s) and/or one or several load(s) that resolve the congestion, and to generate the output based on the one or several updated setpoint(s) to cause the future congestion to be resolved (e.g., by changing the operation of the generator(s) and/or load(s)). The processing system or a distribution system control system that comprises or is coupled to the processing system may cause the generator(s) and/or loads to operate in accordance with the one or several updated setpoint(s) at times in the future.

Thereby, the processing system is operative to determine settings that resolve a future congestion. When operating to resolve presently existing and/or future congestions, the at least one processing system may be configured to generate a set of time-sequentially applicable updated setpoints for one or several of the generators and/or loads. The set of time-sequentially applicable updated setpoints may comprise a time series of setpoints. The set of time-sequentially applicable updated setpoints may be determined for operating conditions specifying the generator power(s) (e.g., the generator power levels) and load power(s) in a time-dependent manner, i.e., as operating conditions time series data.

Thereby, the settings (such as setpoints) may be determined and applied in a time-varying manner to prevent or eliminate congestions as they arise as a function of time.

To process time-varying operating conditions to generate time-varying settings (e.g., setpoints for generators and/or loads), the at least one processing circuit may be operative to perform the congestion identification, the congestion resolution processing, and a verification that the results of the congestion resolution processing resolve the congestion for several distinct points in time (e.g., for each point in time corresponding to samples of a time series). The processing for any of the points in time may be performed independently of the processing for the other points in time.

Thereby, the settings (such as setpoints) may be determined and applied efficiently even when the operating conditions vary in a time-dependent manner.

The future operating conditions may comprise planned operating conditions, as set by a distribution system control system. The future operating conditions may comprise forecast operating conditions, as determined based on information retrieved from external data sources, such as weather forecast data resources.

Thereby, potential future congestions may be identified and resolved based on a distribution system operator's planning and/or using forecast data resources related to conditions that have the potential of affecting the power generation and/or consumption (such as weather data).

The processing system may comprise at least one interface operative to receive the operating conditions. The at least one interface may comprise a data interface, which may be wired or wireless, or an HMI. The processing system may be configured to retrieve the operating conditions via the data system from a distribution system control system circuit or from a storage system in which the operating conditions are stored.

The processing system may be operative to provide the output via the at least one interface for, e.g., outputting via the HMI or automatic use by the distribution system control system in controlling generators and/or loads.

According to another aspect of the invention, there is provided a distribution system control system, comprising the processing system of any one of the aspects or embodiments discloses herein.

The distribution system control system may be operative to perform a generator and/or load curtailment based on the results of the congestion resolution processing.

Thereby, results of the processing may be used in modifying the operation of the generators(s) and/or load(s) so as to prevent or eliminate congestions. The risk of human operator errors and/or unfair curtailment decisions is mitigated.

According to another aspect of the invention, there is provided a system, comprising: a distribution grid, at least one generator and/or at least one load, and the processing system of any aspect or embodiment or the distribution system control system of any aspect of embodiment operative to determine a curtailment of the at least one generator and/or at least one load based on the congestion resolution processing.

The system is operative such that results of the processing may be used in modifying the operation of the generators(s) and/or load(s) so as to prevent or eliminate congestions. Thereby, results of the processing may be used in modifying the operation of the generators(s) and/or load(s) so as to prevent or eliminate congestions. The risk of human operator errors and/or unfair curtailment decisions is mitigated.

The processing system or distribution system control system is operative such that the output comprises a command that causes curtailment of the at least one generator and/or at least one load. Thereby, results of the processing may be used in modifying the operation of the generators(s) and/or load(s) so as to prevent or eliminate congestions. The risk of human operator errors and/or unfair curtailment

According to another aspect of the invention, there is provided a processing method. The method comprises performing, by at least one processing circuit, a congestion identification to identify a congestion in a section of a distribution grid of an electric power grid; performing, by the at least one processing circuit, a congestion resolution to mitigate or eliminate the congestion, the congestion resolution processing comprising a determination of at least one element that is to be controlled to mitigate or eliminate the identified congestion, the at least one element comprising at least one generator and/or at least one load, the at least one processing circuit being operative to determine the at least one element based on power transfer distribution factors, PTDFs, determined for at least the section of the power grid; and generating, by the at least one processing circuit, output that is provided via at least one interface of the processing system based on the congestion resolution processing.

The effects attained by the processing method correspond to the effects described in association with the processing system.

The processing method may be performed automatically by a processing system, e.g., by the processing system, the distribution system control system, or the system of any aspect or embodiment disclosed herein.

The PTDFs are indicative of a sensitivity of the power at the location of the congestion to changes made in various locations of the distribution grid. Thus, the processing method performs a sensitivity-based adjustment of settings (such as setpoints) of one or more generators and/or one or more loads.

The congestion identification and congestion resolution processing may use operating conditions of the distribution grid as input. The operating conditions may comprise setpoints for generators. The operating conditions may comprise setpoints for loads. The operating conditions may comprise measurements or forecasts for load powers. The operating conditions may determine generator and load powers for all generators and loads, either for a current time, a time in the past (e.g., when analyzing past situations), or a time in the future (e.g., when determining suitable curtailment actions in a predictive manner). When the processing method is performed for forecasting curtailment actions that are suitable for operating conditions in the future, the operating conditions may be based inter alia on weather forecast data or other predictive information that affects power generation and/or load powers.

The congestion resolution processing of the processing method may comprise a determination of an updated setting for each element of the at least one element based on the PTDFs. The at least one processing circuit may be operative to generate the output based on the updated setting.

Thereby, the output may indicate the updated setting, such as an updated setpoint, determined by the processing system as being suitable for resolving the congestion. The output may be used by a control system to which the processing system is coupled or of which the processing system may be a part, to automatically adjust the current or future operation based on the determined updated setting. Thus, the output may be operative to cause a change in generator and/or load operation.

In the processing method, the updated setting may comprise an updated setpoint for the at least one element.

Thereby, the output may indicate the updated setpoint, determined by the processing system as being suitable for resolving the congestion. The determination of the updated setpoint is performed automatically by the processing system.

In the processing method, the updated setting may comprise a curtailment of the determined at least one generator and/or at least one load.

Thereby, curtailment actions and an amount by which power is to be curtailed are determined automatically by the processing system.

The processing method may comprise determining the curtailment based on the PTDFs.

Thereby, the suitability of various generators and/or loads of the distribution grid for causing the congestion to be resolved may be taken into account when curtailing one or more generator(s) and/or load(s).

The processing method may comprise determining the curtailment based on a number of elements to be controlled to mitigate or eliminate the identified congestion.

Thereby, the processing system may determine the curtailment sequentially for one generator and/or load at a time, making the determination particularly efficient. Thus, a greedy redispatch may be performed, for example.

The processing method may comprise determining the curtailment independently of a number of elements to be controlled to mitigate or eliminate the identified congestion.

Thereby, the processing system may distribute the corrective action that is required over several generators and/or loads, resulting in a fairer curtailment action. For illustration, a proportional redispatch may be performed.

In the processing method, the PTDFs may be complex-valued.

Thereby, better congestion resolution results are obtained. Surprisingly, the congestion resolution results obtained when determining the PTDFs as complex-values PTDFs and then using the real part (i.e., the active part) thereof for determining the element(s) to be curtailed and the respective curtailment amounts outperform the results that would be obtained if only real-valued PTDFs were determined at the outset.

The processing method may comprise performing the congestion resolution processing based on a real part (i.e., the active part) of the PTDFs.

Thereby, better congestion resolution results are obtained. Surprisingly, the congestion resolution results obtained when determining the PTDFs as complex-values PTDFs and then using the real part (i.e., the active part) thereof for determining the element(s) to be curtailed and the respective curtailment amounts outperform the results that would be obtained if only real-valued PTDFs were determined at the outset.

The processing method may comprise performing the congestion resolution processing independently of the imaginary part of the PTDFs.

Thereby, better congestion resolution results are obtained. Surprisingly, the congestion resolution results obtained when determining the PTDFs as complex-values PTDFs and then using the real part (i.e., the active part) thereof for determining the element(s) to be curtailed and the respective curtailment amounts outperform the results that would be obtained if only real-valued PTDFs were determined at the outset.

In the processing method, the PTDFs comprise alternating current (ac) PTDFs.

Thereby, better congestion resolution results are obtained. Surprisingly, the congestion resolution results obtained when determining the PTDFs as ac-PTDFs and then using the real part (i.e., the active part) thereof for determining the element(s) to be curtailed and the respective curtailment amounts outperform the results that would be obtained if only real-valued PTDFs were determined at the outset.

The processing method may comprise performing a PTDF determination to determine the PTDFs.

Thereby, the determination of the PTDFs may be implemented in a processing system and may be repeated as the need arises, e.g., in response to a temporary change in distribution grid topology.

The PTDF determination may comprise a power flow computation.

Thereby, processing techniques (namely power flow computation) and the information required therefor (such as admittance and Jacobian matrices) may be used also in the process of determining the PTDFs.

The processing method may comprise determining derivatives of power with respect to voltage magnitude for PV and PQ buses of the section of the distribution grid, to determine some of the PTDFs (such as the PTDFs of the PV buses and the real parts of the PTDFs for the PQ buses). The processing method may comprise determining derivatives of power with respect to phase angle for PQ buses of the section of the distribution grid, to determine some of the PTDFs (such as the imaginary parts of the PTDFs for the PQ buses). This allows the PTDFs to be determined without requiring an inversion of a sensitivity matrix.

Thereby, the PTDFs may be determined efficiently and reliably. Congestion resolution can be performed in an efficient manner.

The processing method may comprise determining derivatives of power with respect to voltage magnitude for PV and PQ buses of the section of the distribution grid to determine matrix elements of a sensitivity matrix and multiplying a real part of the sensitivity matrix with incremental voltage changes to determine at least some of the PTDFs.

Thereby, the PTDFs may be determined efficiently and reliably. Congestion resolution can be performed in an efficient manner.

The processing method may comprise determining the PTDFs without using an inversion of the sensitivity matrix.

Thereby, the PTDFs may be determined efficiently and reliably. Congestion resolution can be performed in an efficient manner.

The processing method may comprise determining the PTDFs such that each PTDF quantifies a sensitivity of a line power of the distribution grid on a power injection of a PV or PQ bus of the distribution grid.

Thereby, quantities are determined which are particularly suitable for identifying which generators and/or loads are to be curtailed for resolving a congestion at a line or a transformer.

The processing method may comprise determining the PTDFs as matrix elements of a PTDF matrix, wherein rows of the PTDF matrix are associated with lines of the distribution grid (or a section thereof) and columns of the PTDF matrix are associated with buses of the distribution grid (or the section thereof) (or vice versa, with the rows being associated with buses and the columns being associated with lines). The PTDF matrix may have a number of rows that is equal to a number of lines in the distribution grid (or a section thereof) and a number of columns that is equal to a number of PV buses plus twice a number of PQ buses in the distribution grid (or a section thereof); or, alternatively, a number of columns that is equal to a number of lines in the distribution grid (or a section thereof) and a number of rows that is equal to a number of PV buses plus twice a number of PQ buses in the distribution grid (or a section thereof).

Thereby, the PTDFs may be determined using techniques and routines that are well established in the field of transmission systems and that are available to the skilled person.

The processing method may comprise applying scaling factors to admittances used in the power flow computation when determining the PTDFs. The processing method may comprise performing a scaling of admittances when determining the PTDFs to account for the fact that admittances in a distribution grid are typically less than admittances in a transmission grid. The scaling may be performed prior to performing power flow and PTDF calculations.

Thereby, the PTDFs may be determined using techniques and routines that are well established in the field of transmission systems and that are available to the skilled person.

The processing method may comprise performing the congestion resolution processing based on both the PTDFs and a merit order relating to loads and/or generators.

Thereby, the merit order may be taken into consideration by the at least one processing circuit when determining curtailment of generators and/or loads.

The processing method may comprise enabling a user to specify a merit order relating to loads and/or generators of the distribution grid via an HMI.

Thereby, the merit order may be specified by the distribution system operator at the HMI of the processing system.

The processing method may comprise retrieving the merit order via a data interface.

Thereby, the merit order can be retrieved from a control system or a storage system in which it is stored.

The processing method may comprise determining the at least one element based on the merit order.

Thereby, the merit order may be taken into consideration by the processing system when determining which generators and/or loads are to be curtailed.

The processing method may comprise determining the updated setting based on the merit order.

Thereby, the merit order may be taken into consideration by the processing system when determining a curtailment amount for the generators and/or loads to be curtailed.

The processing method may comprise performing a ranking of generators and/or loads of the section based on the PTDFs and the merit order, wherein the congestion resolution processing is performed based on the ranking.

Thereby, the merit order and the sensitivity of lines and/or transformer loads to changes in generator and/or load power level as reflected by the PTDFs may be used in combination to perform the congestion resolution processing.

The processing method may be operative such that the congestion resolution processing is performed separately for each of several sections of the distribution grid.

Thereby, stability of the processing is increased and the processing can be performed sufficiently quickly to react to changing conditions (such as changing weather conditions and/or changing load powers). The congestion resolution processing may be performed sequentially for the several sections. The congestion resolution processing may be performed in parallel for at least some, optional all, of the several sections.

The processing method may comprise automatically determining a plurality of sections of the distribution grid based on a distribution grid topology, wherein the congestion identification and the congestion resolution processing are performed for each section of the plurality of sections having a congestion.

Thereby, the sections may be identified automatically. The method may comprise retrieving the distribution grid topology from a system configuration file or other configuration description of the distribution grid. The distribution grid topology may be defined by at least a single line diagram of the distribution grid.

In the processing method, the congestion identification and the congestion resolution processing may be performed independently for each of the plurality of sections.

Thereby, stability of the processing is increased. The processing can be performed sufficiently quickly to react to changing conditions (such as changing weather conditions and/or changing load powers).

The processing method may comprise identifying, based on distribution grid topology, radial feeder sections and loop sections, and wherein the at least one processing circuit may be operative to determine the plurality of sections as a union of the radial feeder sections and the loop sections.

Thereby, sections suitable for separately performing congestion identification and resolution processing may be determined automatically by the processing system.

The processing method may comprise performing a verification to confirm that the congestion resolution processing mitigates or eliminates the identified congestion before generating the output.

Thereby, reliability of the congestion resolution is enhanced.

The verification may comprise updating the PTDFs based on the congestion resolution processing.

Thereby, updated PTDFs are available for further use, e.g., for performing a further congestion resolution processing and/or for determining that the updated settings resolve the congestion.

The verification may comprise performing a further power flow computation.

Thereby, reliability of the congestion resolution is enhanced in particular when using redispatch schemes which do not lend themselves to verifying that the congestion is resolved based on PTDFs alone.

The output may comprise an output for use by a distribution system operator (DSO).

Thereby, the results of the congestion resolution processing (such as updated setpoints for generators and/or loads) may be provided to a control component of a distribution system control system, an energy management system (EMS), and/or a power management system (PMS), to thereby influence operation of the distribution grid.

The output may comprise a command operative to adjust setpoints of the determined at least one generator and/or at least one load.

Thereby, the results of the congestion resolution processing (such as updated setpoints for generators and/or loads) can affect control operations acting on the distribution grid, e.g., by curtailing generators and/or loads.

In the processing method, the congestion resolution processing determines one or several updated setpoints for generators and/or loads for presently existing operating conditions (i.e., for operating conditions that prevail at the time of the processing). The presently existing operating conditions may comprise presently existing setpoints of all generators of the section of the distribution grid, and information on presently existing load powers of all loads of the section of the distribution grid. The information on presently existing load power may comprise measurements obtained under the presently existing operating conditions and/or presently existing setpoints for loads. In the processing method, a presently existing congestion may be identified, one or several updated setpoint(s) may be determined for one or several generator(s) and/or one or several load(s) that resolve the congestion, and the output may be generated based on the one or several updated setpoint(s) to cause the presently existing congestion to be resolved (e.g., by changing the operation of the generator(s) and/or load(s)). The processing method or a distribution system control method comprising the processing method may cause the generator(s) and/or loads to operate in accordance with the one or several updated setpoint(s).

Thereby, the processing method determines settings that resolve a presently existing congestion.

Alternatively or additionally, the congestion resolution processing determines one or several updated setpoints for generators and/or loads for future operating conditions (i.e., for operating conditions that prevail at the time of the processing). The future operating conditions may comprise future setpoints of all generators of the section of the distribution grid, and information on future load powers of all loads of the section of the distribution grid. The information on future load power may comprise measurements obtained under the future operating conditions and/or future setpoints for loads. In the processing method, a presently existing congestion may be identified, one or several updated setpoint(s) may be determined for one or several generator(s) and/or one or several load(s) that resolve the congestion, and the output may be generated based on the one or several updated setpoint(s) to cause the presently existing congestion to be resolved (e.g., by changing the operation of the generator(s) and/or load(s)). The processing system or a distribution system control system that comprises or is coupled to the processing system may cause the generator(s) and/or loads to operate in accordance with the one or several updated setpoint(s) at times in the future.

Thereby, the processing method determines settings that resolve a future congestion.

When operating to resolve presently existing and/or future congestions, the at least one processing method may generate a set of time-sequentially applicable updated setpoints for one or several of the generators and/or loads. The set of time-sequentially applicable updated setpoints may comprise a time series of setpoints. The set of time-sequentially applicable updated setpoints may be determined for operating conditions specifying the generator power(s) (e.g., the generator power levels) and load power(s) in a time-dependent manner, i.e., as operating conditions time series data.

Thereby, the settings (such as setpoints) may be determined and applied in a time-varying manner to prevent or eliminate congestions as they arise as a function of time.

To process time-varying operating conditions to generate time-varying settings (e.g., setpoints for generators and/or loads), the processing method may perform the congestion identification, the congestion resolution processing, and a verification that the results of the congestion resolution processing resolve the congestion for several distinct points in time (e.g., for each point in time corresponding to samples of a time series). The processing for any of the points in time may be performed independently of the processing for the other points in time.

Thereby, the settings (such as setpoints) may be determined and applied efficiently even when the operating conditions vary in a time-dependent manner.

The future operating conditions may comprise planned operating conditions, as set by a distribution system control system. The future operating conditions may comprise forecast operating conditions, as determined based on information retrieved from external data sources, such as weather forecast data resources.

Thereby, potential future congestions may be identified and resolved based on a distribution system operator's planning and/or using forecast data resources related to conditions that have the potential of affecting the power generation and/or consumption (such as weather data).

The processing method may comprise receiving the operating conditions at at least one interface. The at least one interface may comprise a data interface, which may be wired or wireless, or an HMI. The processing method may comprise retrieving the operating conditions via the data system from a distribution system control system circuit or from a storage system in which the operating conditions are stored.

The processing method may provide the output via the at least one interface for, e.g., outputting via the HMI or automatic use by the distribution system control system in controlling generators and/or loads.

According to another aspect of the invention, there is provided a distribution system control method, comprising the processing method of any one of the aspects or embodiments discloses herein. The distribution system control method may be performed automatically by a distribution system control system, e.g., by the distribution system control system of any aspect or embodiment disclosed herein.

The distribution system control method may be operative to perform a generator and/or load curtailment based on the results of the congestion resolution processing.

Thereby, results of the processing may be used in modifying the operation of the generators(s) and/or load(s) so as to prevent or eliminate congestions. The risk of human operator errors and/or unfair curtailment decisions is mitigated.

According to another aspect of the invention, there is provided a method of operating a system comprising a distribution grid, at least one load, and at least one generator. The method comprises curtailing, by a distribution system control system, the at least one generator and/or the at least one load based on a result of the processing method according to any one aspect or embodiment disclosed herein.

According to further embodiments, there is provided machine-readable instruction code which, when executed by at least one programmable circuit, causes the at least one programmable circuit to perform the processing method, the control method, or the operation method according to any aspect or embodiment disclosed herein.

According to further embodiments, there is provided a non-transitory storage medium having stored thereon machine-readable instruction code which, when executed by at least one programmable circuit, causes the at least one programmable circuit to perform the processing method, the control method, or the operation method according to any aspect or embodiment disclosed herein.

Various effects and advantages are attained by embodiments of the invention. For illustration, the processing systems and methods according to embodiments provide enhanced techniques of resolving congestions. The methods, devices, and systems operative to perform congestion resolution in an efficient manner. The methods, devices, and systems that can determine which generators and/or loads are to be curtailed to resolve a congestion, thereby assisting in distribution system control. The methods, devices, and systems are operative to determine the generators and/or loads to be curtailed in a fair and unbiased manner, based on objective criteria.

The systems and methods can be used in association with an electric power grid having renewable energy sources and/or battery-based or mechanical energy storage systems (or other loads coupled to the distribution grid in a time-dependent, controllable manner), without being limited thereto.

### BRIEF DESCRIPTION OF THE DRAWINGS

Embodiments of the invention will be described with reference to the drawings in which similar or identical reference signs designate elements with similar or identical configuration and/or function.

FIG. 1 is a block diagram of a processing system.

FIG. 2 is a block diagram of processing circuit(s) of the processing system.

FIG. 3 is a diagram of a system comprising the processing system.

FIG. 4 is a diagram of a system comprising the processing system.

FIG. 5 is a flow chart of a method.

FIG. 6 is a flow chart of a method.

FIG. 7 is a flow chart of a method.

FIG. 8 is a flow chart of a method.

FIG. 9 is a diagram of a distribution grid.

FIG. 10 is a diagram of sections of the distribution grid.

FIG. 11 is a flow chart of a method.

FIG. 12 is a flow chart of a method.

FIG. 13 is a diagram of a distribution grid.

FIG. 14 is a diagram of a distribution grid.

FIG. 15 is a diagram illustrating operation of the processing system for determining future setpoints.

FIG. 16 is a block diagram of a system comprising the processing system and a control system.

### DETAILED DESCRIPTION OF EMBODIMENTS

Embodiments of the invention will be described with reference to the drawings. In the drawings, similar or identical reference signs designate elements with similar or identical configuration and/or function.

While embodiments will be described in association with processing systems and methods of determining setpoints of generators and/or loads, the embodiments are not limited thereto. The techniques disclosed herein may be used to determine other settings, such as a timing of time-dependent coupling operations. The determined setpoints or other settings may be applied to modify the operation of a distribution grid under control of a distribution system control system.

While embodiments will be described in association with a distribution grid having power generating units comprising renewable energy resources, the embodiments are not limited thereto.

In accordance with the invention, there are provided processing methods, processing systems, control methods and control systems for determining settings (such as setpoints) for generators and/or loads of a distribution system. The generators and/or loads are coupled to a distribution grid, e.g., via buses. As described in more detail herein, the processing methods, processing systems, control methods and control systems are operative to automatically determine which elements (generators and/or loads) are to be curtailed, using information on sensitivity information that quantifies how sensitive a location at which a congestion occurs (such as a line, a transformer, or a bus) is to a change in power for any of the elements (generators and/or loads) that can be curtailed. More specifically, the processing methods, processing systems, control methods and control systems are operative to use power transfer distribution factors (PTDFs) determined for at least a section of the power grid to determine which generators and/or loads connected to that section of the power grid are to be curtailed to resolve a congestion.

By taking into consideration the PTDFs for determining which generators and/or loads are to be curtailed and for determining the curtailment amounts, the processing methods, processing systems, control methods and control systems disclosed herein provide a sensitivity-based redispatch for distribution grids.

The systems and methods disclosed herein may be operative to also take into consideration a merit order of generators and/or loads. The merit order may be set by a distribution system operator (DSO) or otherwise. Thus, the systems and methods may be operative to perform a redispatch of a distribution system that is based on both the merit order and the sensitivities specified by the PTDFs. The priority- and sensitivity-based redispatch system and method can automatically resolve distribution grid congestions by identifying which loads and generators impact the congestions and curtailing them heuristically according to the merit order. This can be done in both a real-time- or forecast-based manner. The techniques disclosed herein are suitable for predicting and resolving a potential problem before it occurs. If multiple generators are assigned the same merit order, they can be curtailed heuristically based on their ability to resolve the congestions (as specified by the PTDFs), optionally further based on a desired curtailment scenario.

Methods and systems disclosed herein are operative to determine settings (such as setpoints) for generators and/or loads that resolve an identified congestion. As used herein, the terms “determining” and “determine” encompass an approximate determination of the respective quantity, such as an estimation of the respective quantity.

As used herein, the term “congestion” refers to a situation in which an asset is overloaded or a bus voltage violation occurs. The congestion of the asset may comprise a congestion of a line and/or a congestion of a transformer. The congestion may be a situation in which a grid overload prevents electricity from reaching a consumer. The congestion may comprise a congestion that already exists at runtime operation of the processing system and/or execution of the method according to an embodiment. The congestion may comprise a congestion that is predicted to exist at a time period in the future as compared to the runtime operation of the processing system and/or execution of the method according to an embodiment.

As used herein, the term “congestion resolution” refers to actions suitable to eliminate a presently existing congestion or suitable to prevent a congestion from occurring (that would occur or can occur absent the congestion resolution).

The techniques disclosed herein are operative to facilitate operation of a distribution grid by providing automated techniques of determining settings that resolve a congestion in the distribution grid. As used herein, the term “distribution grid” encompasses in particular a distribution grid operative to transmit power at voltages of from 2 kV to 220 kV, such as a high voltage distribution grid (where voltages are typically between 60 kV and 220 kV) or a medium voltage distribution grid (where voltages may be, e.g., between 6 kV and 60 kV). Generators based on renewable energy resources (such as one or several distributed energy resources (DERs) configured in a manner compatible with IEEE 1547-2018, without being limited thereto).

As used herein, the term “distribution system” is used to refer to a system that comprises the distribution grid and generators and loads connected to the distribution grid, as well as the respective connection infrastructure (such as feeders, inverters, etc.).

As used herein, the term “power transfer distribution factor” refers to a quantity that indicates an incremental change in power that occurs on a transmission line due to real power transfers between two regions. The PTDFs is also referred to as a sensitivity factor or sensitivity coefficient in the art, as it can quantify a sensitivity of line power to incremental transfers of powers between buses. The regions can be defined by areas, zones, super areas, single buses, injection groups or the system slack. The PTDFs may in particular be quantities that indicate indicates an incremental change in power that occurs on a transmission line of the distribution grid due to real power transfers between buses of the distribution system. Additional information on PTDFs and determination techniques are disclosed in, e.g., A. Kumar and S. C. Srivastava, “AC Power Transfer Distribution Factors for Allocating Power Transactions in a Deregulated Market”, IEEE Power Engineering Review, July 2002; D. Šošić et al., “Features of Power Transfer Distribution Coefficients in power System Networks”, INFOTEH-JAHORINA Vol. 13, March 2014, pp. 86-90; and I. Chychykina, “Comparison of Different Redispatch Optimization Strategies.” Res Electricae Magdeburgenses. Magdeburger Forum zur Elektrotechnik. Jg. 7, Band 78, 2019. ISSN: 1612-2526 (in particular pp. 18 et seq).

As used herein, the term “power” refers to electric power unless explicitly stated otherwise.

The processing methods, processing systems, control methods and control systems disclosed herein may be applied to the entire distribution grid or any section of the distribution grid. A distribution grid may be broken up into various sections, with the congestion resolution processing being performed independently for each of the various sections.

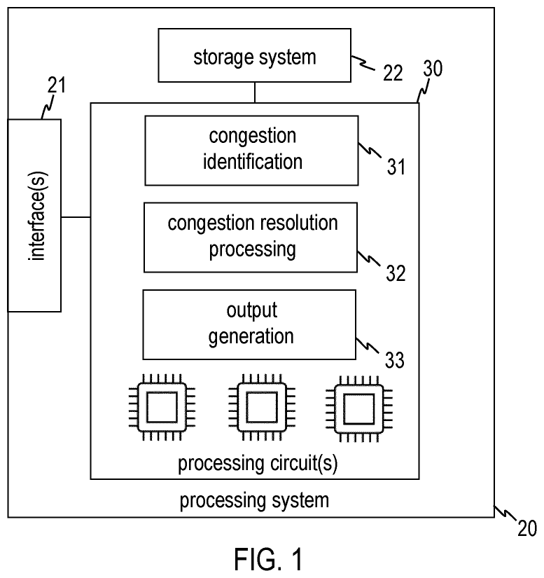

FIG. 1 shows a processing system 20 operative to perform a congestion resolution processing. The processing system 20 is operative to determine suitable countermeasures to reduce or eliminate a congestion. The processing system 20 is more specifically operative to determine which one or more element(s), such as generator(s) and/or load(s) of the distribution system, are to be curtailed or, more generally, for which of the element(s) settings are to be adjusted to resolve the congestion. The processing system 20 may be operative to determine curtailment amounts and may determine new settings (such as new setpoints) based on the curtailment amounts and the original (present or future) settings. The processing system 20 may be operative to perform output operations, such as control operations, which cause the curtailment to be implemented to reduce or eliminate the congestion. To this end, the processing system 20 may be comprised by a distribution system control system (such as a distribution system control center) or may be communicatively coupled to the distribution system control system.

The processing system 20 may be operative to determine countermeasures for a currently existing congestion (i.e., a congestion that exists at runtime operation of the processing system 20) or a congestion expected at a time period later than the runtime operation that is disclosed in detail below, based on current and/or future operating conditions.

Importantly, and as described in more detail herein, the processing system 20 uses a sensitivity-based congestion resolution processing to determine which one or several element(s) (such as load(s) and/or generator(s)) of the distribution system are to be curtailed. The sensitivity-based congestion resolution processing is based on power transfer distribution factors (PTDFs). Thereby, the processing system is operative to determine, in a systematic and objective manner, for which generator(s) and/or load(s) an adjustment of settings (such as, without limitation, a curtailment) has the potential to resolve the congestion(s) at the respective location(s) of the congestion(s). In particular, the PTDFs may be used to identify one or several buses to which or from which power is to be shifted to resolve the congestion at any given line or transformer.

The processing performed by the processing system 20 may use at least distribution grid data and operation parameters (such as generator setpoints and load powers) for performing congestion identification and congestion resolution processing. The distribution grid data may comprise an admittance matrix, a Jacobian matrix, and information on grid topology. The distribution grid data and operation parameters comprise all data required to perform a power flow computation and a PTDF computation, as will be explained in more detail herein.

The processing system 20 may be implemented as an apparatus comprising an apparatus housing in which the components illustrated in FIG. 1 are accommodated. The processing system 20 may be implemented as a combination of several apparatuses that are communicatively coupled to each other. The processing system 20 may be operative to be used in combination with, and to co-operate with, a control system for at least part of the power grid, such as distribution system control system.

The processing system 20 comprises at least one processing circuit 30. The at least one processing circuit 30 is operative to be coupled to at least one interface 21. The at least one processing circuit 30 is configured to receive operating conditions of the distribution system. The at least one processing circuit 30 is operative to perform a congestion identification 31. The at least one processing circuit 30 is operative to perform a congestion resolution processing 32, based on the congestion identification 31. The congestion resolution processing 32 is performed in a sensitivity-based manner, based on PTDFs that are useful to identify which generators and/or loads have the potential of reducing or eliminating the congestion when adjusted. The at least one processing circuit 30 is operative to perform an output generation 33 to generate output (such as a command) based on the congestion resolution processing 32.

The at least one processing circuit 30 may comprise any one or any combination of integrated circuits, integrated semiconductor circuits, processors, controllers, application specific integrated circuits (ASICs), field programmable gate arrays (FPGAs), circuit(s) including quantum bits (qubits) and/or quantum gates, without being limited thereto.

The processing system 20 may comprise an output interface separate from the interface 21 to provide the output or may provide the output via the at least one interface 21. The processing system 20 may be operative to output a command that causes execution, or is otherwise based on, settings determined in the congestion resolution processing 32.

The processing system 20 may be operative to output a command that causes one or several of: provision of the setting (such as a setpoint that implements a generator curtailment and/or load curtailment) to a distribution system control system; controlling a human machine interface (HMI) to output information on the determined settings; controlling one or several controllable devices of the distribution grid to resolve a presently existing or expected future curtailment.

A storage system 22 of the processing system 20 may be operative to store distribution system data used in the congestion identification and/or congestion resolution processing. The at least one processing circuit 30 may be operative to retrieve the distribution system data from the storage system 22 for use in performing the congestion identification 31 and/or congestion resolution processing 32. The retrieved distribution system data may comprise data useful in performing the congestion identification 31 (such as the admittance matrix and the Jacobian matrix used in combination with power injections at the various nodes of the distribution system topology to determine which lines and/or transformers are overloaded). The retrieved distribution system data may comprise data useful in performing the congestion resolution processing 32 (such as the PTDF matrix determined for the distribution grid, a merit order that may be defined by the distribution system operator, and data required to perform a power flow computation for checking the results of the congestion resolution processing 32).

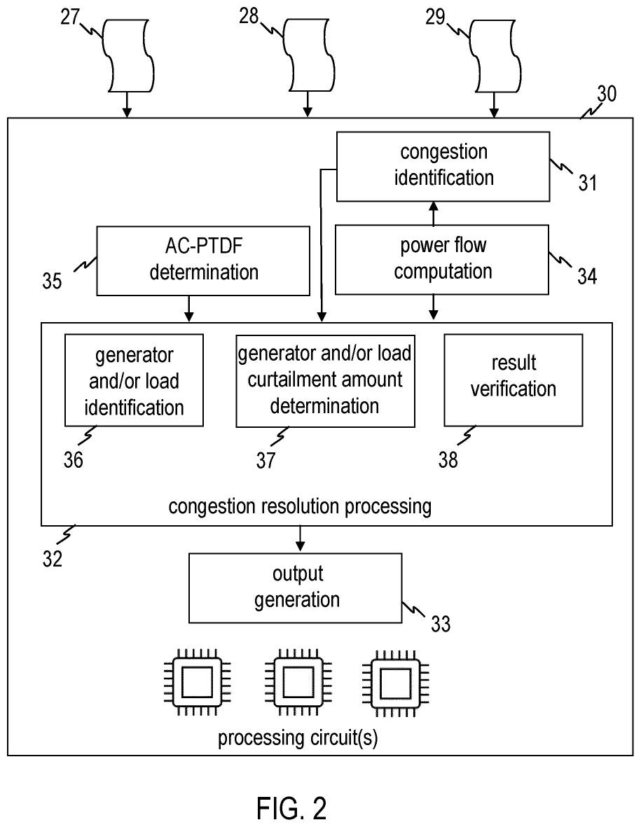

FIG. 2 is a schematic block diagram representation of the at least one processing circuit 30. The at least one processing circuit 30 is operative to perform the congestion identification 31, the congestion resolution processing 32, and the output generation 33. To perform these operations, the at least one processing circuit 30 uses operating conditions 27. The operating conditions may be obtained from a control system and/or from measurement instrumentation. The operating conditions may comprise generator powers and load powers. The at least one processing circuit 30 further uses distribution system data 28 which may include all data required for performing a power flow computation and a PTDF computation. The distribution system data 28 may also comprise data specifying the operation range(s) for the loads and/or generators, which may be used to determine at which lines, buses, and/or transformers a congestion exists at present or in the future. The at least one processing circuit 30 may further perform the congestion resolution processing 32 based on a merit order 29. The merit order 29 may be received via a HMI and may be stored in the storage system 23, or may be persistently stored in the storage system 23 when commissioning the processing system 20.

The at least one processing circuit 30 may be operative to perform a power flow computation 34, using the distribution system data 28 and the operating conditions 27. The power flow computation 34 may be performed for the operating conditions 27. When the operating conditions 27 define a time series of different operating conditions, the power flow computation (and the other processing disclosed herein) can be performed independently for each of the various times of the time series. Results of the power flow computation 34 may be used to identify lines, transformers, and/or buses at which a congestion exists. To this end, the congestion identification 31 may compare the results of the power flow computation 34 to operation ranges defined by the distribution system data 28, for example. Alternatively or additionally, the at least one processing circuit 30 may be operative to control the HMI to enable the operator or engineer to input permissible operation ranges for lines, transformers, and/or buses.

The at least one processing circuit 30 may be operative to perform a PTDF determination 35. While the PTDF determination 35 may be executed by the processing system 20, the PTDF matrix may also be computed by another computing system and provided to the processing system 20 for use. Irrespective of whether the PTDF determination is performed by the processing system 20 or whether the processing system 20 uses PTDFs already determined by another computing system, the PTDFs are preferably AC-PTDFs. Tests have shown that determining AC-PTDFs and using the real part (i.e., the active part) of the AC-PTDFs for determining setting(s) (such as setpoints) of one or several generators and/or loads provides improved results in terms of congestion resolution (as compared to, e.g., determining and using only DC-PTDFs). The AC-PTDFs may be PTDFs that indicate the incremental change in line power in response to a change in a bus power, for example. I.e., the lines and columns of the distribution system may be linked to rows and columns (or vice versa) of the AC-PTDF matrix. For PV buses, there may be one column (or one row) of the AC-PTDF matrix per bus. For PQ buses, there may be two columns (or two rows) of the AC-PTDF matrix per bus, corresponding to the in-phase and out-of-phase components.

Results of the congestion identification and at least the real part (i.e., the active part) of the AC-PTDFs are used by the congestion resolution processing 32. The congestion resolution processing 32 is performed selectively only if there is a congestion in at least one area of the distribution grid. The various further processing operations may be limited to the at least one area in which a (presently existing or predicted future) congestion has been identified. Congestions in different areas may be dealt with independently of each other, either using sequential processing or using parallel processing.

To determine counter-measures that resolve the congestion(s), the at least one processing circuit 30 performs an identification 36 of one or several generator(s) and/or load(s), based on the PTDFs. The one or several generator(s) and/or load(s) may be identified such that, according to the PTDFs, an adjustment of the power of the respective generator(s) and/or load(s) influences the power at at least one line at which a congestion has been identified. Additional information may be used to identify the generator and/or load. For illustration, the merit order 29 may optionally already be used to eliminate generators and/or loads from consideration that are not to be curtailed (based on the merit order).

To determine the counter-measures that resolve the congestion(s), the at least one processing circuit 30 determines settings for the generator(s) and/or load(s) determined by the identification 36. The settings may be determined also based on the PTDFs. The settings may be determined based on a magnitude of the congestion determined by the congestion identification 31, e.g., based on a difference of a determined (presently existing or predicted future) line power and a power value permissible for the respective line. The settings may be determined further based on the merit order. Thereby, both the sensitivity quantified by the PTDFs and the merit order may be taken into account when determining which settings that resolve the congestion resolution. The settings may comprise generator setpoints and/or load setpoints. The settings may also comprise timing-related information, such as timing information for connecting and disconnecting controllable loads.

To determine the counter-measures that resolve the congestion(s), the at least one processing circuit 30 may perform a result verification 38. The result verification 38 may comprise a further power flow computation (thereby invoking the power flow computation module 34). Only upon successful verification that the congestion(s) in the section of the distribution grid is resolved, the at least one processing circuit 31 may be operative to generate and provide the output to, e.g., apply new setpoints to generators and/or loads or otherwise curtail generators and/or loads. If the power flow computation performed at the result verification 38 shows that the congestion has been reduced but not yet entirely resolved, the curtailment determination 38 may be invoked again to further curtail generators and/or loads.

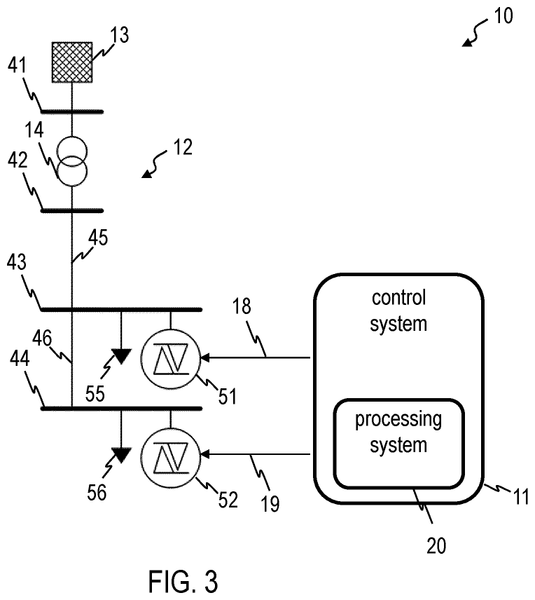

FIG. 3 is a schematic representation of a system 10 according to an embodiment. The system comprises a power distribution system 12 coupled to, e.g., a transmission grid 13 via a transformer 14 that reduces voltage from a first voltage at bus 41 to a lower second voltage at bus 42. The power distribution system 12 comprises a plurality of lines 45, 46, and a plurality of buses 43, 44. Loads 55, 56 and generators 51, 52 may be connected to the buses 43, 44 via suitable coupling gear such as feeders. For generators 51, 52 that comprise inverter based resourced or other renewable energy resources, the coupling gear may comprise inverters.

A distribution system control system 11 may be operative to control power generation levels of the generators 51, 52 and/or to control controllable loads 55, 56. The distribution system control system 11 may be operative to provide commands 18, 19 based on the output of the processing system 20. The commands 18, 19 may effect a curtailment of the generators 51, 52 and/or loads 55, 56 to resolve a congestion that may be presently existing or predicted for the future. The commands 18, 19 may but do not need to be directly provided to the generators 51, 52. For illustration, for renewable energy resource or a distributed energy resource (DER) compatible with the IEEE 1547™ Series of standards, the commands 18, 19 may be provided to a power management system (PMS) and/or energy management system (EMS) for effecting generator curtailment.

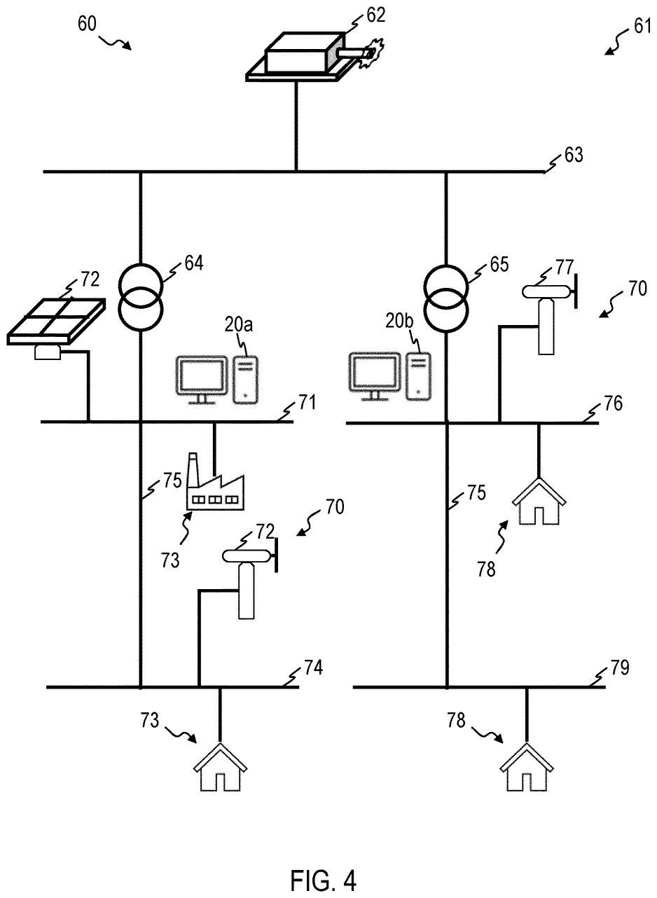

FIG. 4 is a schematic representation of a system 60 according to an embodiment. The system 60 comprises a generator 62, a power transmission system 61, and one or several power distribution systems 70. The power distribution system(s) 70 is/are coupled to, e.g., the power transmission system 61 via transformers 64, 65 that reduce voltage from a first voltage at bus 63 to lower second voltages at buses 71, 76. The power distribution system 70 comprises a plurality of lines 75, and a plurality of buses 71, 74, 76, 78. Loads 73, 78 and generators 72, 77 are connected to the buses by means of suitable coupling gear, such as feeders.

The system 60 comprises one or several processing systems 20a, 20b, each associated with a power distribution system and operative to determine which settings are appropriate for, e.g., generator and/or load curtailment in accordance with the techniques disclosed herein. The one or several processing system 20a, 20b may be, or may be comprised by, distribution system control systems that control generators and/or loads based on the settings determined by the processing systems 20a, 20b.

The processing system 20, 20a, 20b may be operative to receive power measurements from measurement instrumentation in the distribution system. The processing system 20, 20a, 20b may be operative to receive, at its interface, measurements obtained from phasor measurement units (PMUs) for at least approximately determining load powers and/or generator powers. The processing system 20, 20a, 20b may be operative to receive voltage and/or current measurements and to determine, based thereon, at least approximations of load powers and/or generator powers. These powers may be used for performing the congestion identification and/or congestion resolution processing.

By determining settings for generators and/or loads that resolve a presently existing or future congestion of the power distribution grid, the systems and method are operative to redispatch generators and loads using sensitivity information in a merit-based order to resolve network congestions in distribution grids.

The rapidly increasing number of DERs and loads (e.g., EV charging stations) on the distribution level causes several problems in distribution grids including overloads (congestions) and voltage range deviations which may lead to asset damage and potential blackouts. The consequence of ever-increasing presence of DERs, battery storage, and e-mobility at the distribution level is that grid congestions, previously only tackled by Transmission System Operators (TSO) are becoming increasingly relevant to distribution grids, and Distribution System Operators (DSOs) as well. This is exacerbated by the fact that conventional power plants are being decommissioned meaning that TSO and DSOs need to coordinate ever-more-closely to avoid congestions.

Thus, the processing system and methods according to embodiments address a need in the art, namely resolving congestions, that has become more relevant and will continue to become more relevant. Grid congestions may be overloaded assets (e.g., lines and transformers) and/or voltage violations. At a high-level congestion management includes all possible actions in the power grids which can be applied by a network operator to avoid or remedy congestions in the grid. The processing system and method according to embodiments are operative to perform a congestion resolution in accordance with the following main principles:

### Secure Operation of the Power Grid

The curtailment is efficient, non-discriminatory, and transparent
The curtailment lends itself to alignment with environmental goals by prioritizing the in-feed of renewable energy (as may be defined by the merit order, for example)
The curtailment has low complexity of use and returns results quickly, e.g., in near real-time.

At the transmission system level, congestions can be mitigated firstly with grid internal measures such as topology changes. However, in distribution grids there are typically few feasible topologies. To implement congestion management at the distribution level, the processing system 20 and method according to embodiments makes use of controllable assets such as loads or controllable DERs by changing their power consumption/generation to resolve congestions. Adjusting the power output of a generator is known as redispatch. Electricity consumers are not affected by this measure. Redispatch can be done in a cost-based manner whereby power generator owners get compensated for altering their power generation. The altering of a load is known as demand side management. Once again demand side management (DSM) in this context is a cost-based measure as the network operator pays the consumer to take direct control of their consumption. The processing system 20 and method according to embodiments uses objective criteria such as sensitivity (by means of the PTDFs) and merit order to ensure active power balance in the electrical network.

The processing system 20 and method according to embodiments is operative to automatically determine new settings (e.g., new setpoints) for loads and/or generators (i.e., resolve the congestion using redispatch or demand side management) for a presently existing or predicted future congestion, change the settings (e.g., setpoints) of the loads/generators according to different scenarios, and/or change the settings (e.g., setpoints) of the loads/generators according to a merit-based order.

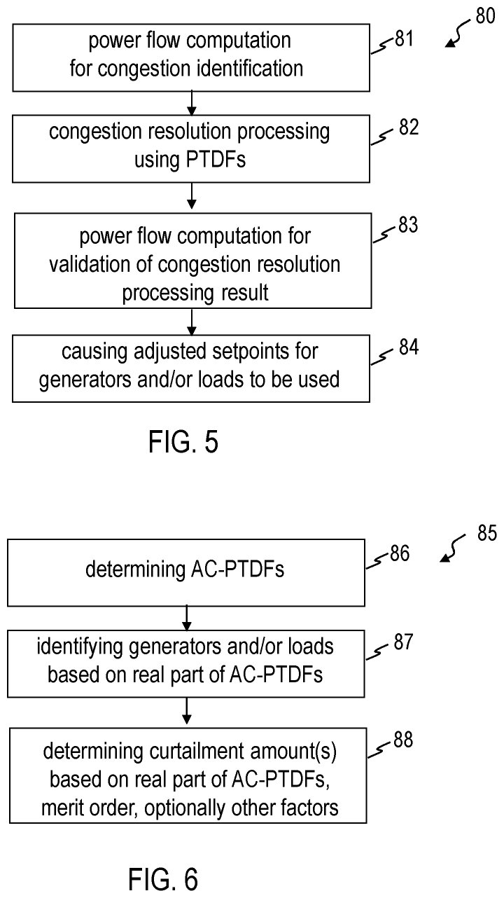

FIG. 5 is a flow chart of a method 80 according to an embodiment. The method 80 may be performed automatically by the processing system 20 or by a distribution system control system comprising the processing system 20.

At process block 81, the at least one processing circuit 31 performs a power flow computation for congestion identification. Congestion identification may comprise identifying, based on the power flow computations, one or several lines of the distribution grid having an overload conditions, one or several transformers of the distribution grid having an overload conditions, and/or one or several buses of the distribution grid having a voltage violation conditions.

At process block 82, the at least one processing circuit 31 performs a congestion resolution processing based on the PTDFs. More specifically, the congestion resolution processing may be based on real parts (i.e., the active part) of AC-PTDFs. The AC-PTDFs may respectively define changes in line power in response to incremental shifts in bus power. The congestion resolution processing may determine settings (such as setpoints and/or times of connection and disconnection) that resolve the identified congestion(s).

At process block 83, the at least one processing circuit 31 performs a further power flow computation using the settings determined at process block 82 for those generators and/or loads for which settings are to be adjusted. If it is determined, based on the further power flow computation, that the congestion(s) is/are resolved by the settings, the method proceedings to process block 84. Otherwise, process block 82 may be repeated to further curtail generators and/or loads.

At process block 84, the at least one processing circuit 31 provides output based on the settings determined to resolve the congestion. The output may comprise commands to generators, loads, a PMS, an EMS, or a HMI, without being limited thereto.

FIG. 6 is a flow chart of a process 85. The process 85 may be performed to implement process blocks 82, 83 of FIG. 5. The process 85 may be performed automatically by the processing system 20 or by a distribution system control system comprising the processing system 20.

At process block 86, AC-PTDFs are determined. Techniques of determining AC-PTDFs are generally available. Examples are provided by, e.g., A. Kumar and S. C. Srivastava, “AC Power Transfer Distribution Factors for Allocating Power Transactions in a Deregulated Market”, IEEE Power Engineering Review, July 2002; D. Šošić et al., “Features of Power Transfer Distribution Coefficients in power System Networks”, INFOTEH-JAHORINA Vol. 13, March 2014, pp. 86-90; and I. Chychykina, “Comparison of Different Redispatch Optimization Strategies.” Res Electricae Magdeburgenses. Magdeburger Forum zur Elektrotechnik. Jg. 7, Band 78, 2019. ISSN: 1612-2526 (in particular pp. 18 et seq.). Conventional existing tools developed for transmission systems may be used, it being preferred to modify these conventional tools by (i) scaling the admittances of the distribution grid to become more similar to those of the transmission system, to thereby ensure applicability and stability of the existing transmission system tool, and (ii) determining both the active and reactive parts of the PTDFs for PQ buses.

Generally, the AC-PTDF may be determined as quotient of an incremental change in a transmission line quantity Δqᵢ for a transmission line l, divided by a power transfer between buses Δtₚ caused by a power transaction from bus M to a bus N. The transmission line quantity Δqᵢ can be an active power or a reactive power. The Jacobian can be used to determine the PTDF (see, e.g., I. Chychykina, “Comparison of Different Redispatch Optimization Strategies.” Res Electricae Magdeburgenses. Magdeburger Forum zur Elektrotechnik. Jg. 7, Band 78, 2019. ISSN: 1612-2526, pp. 18 et seq.).

Preferably, and in order to avoid an inversion of the sensitivity matrix which may be computationally expensive, determining the AC-PTDFs may comprise determining derivatives of power with respect to phase angle (at least for PQ buses) and voltage magnitude (for PQ and PV buses) directly and in sparse formation, without using an inversion of sensitivity matrix which would be computationally very expensive for large dimensions of distribution systems. Thereby, the AC-PTDFs may be determined in an efficient manner, facilitating the determination of updated settings in near real-time. The derivatives of power with respect to phase angle (at least for PQ buses) and voltage magnitude (for PQ and PV buses) represent the sensitivity matrix. A real part of the sensitivity matrix may be multiplied by a vector having incremental voltage changes as vector elements to thereby determine the PTDFs.

At process block 87, the generators and/or loads to be curtailed are determined based on the real part of the AC-PTDFs. This improves the results obtained by the techniques disclosed herein. If desired, the techniques disclosed herein may also be extended to using the Q-part of the AC-PTDFs.

At process block 88, the curtailment amounts are determined based on the real part of the AC-PTDFs. The curtailment amounts may be determined further based on a merit order. The merit order may take into account environmental considerations, e.g., by making a curtailment of renewable energy resources unlikely or preventing the curtailment of renewable energy resources. The processing system may be operative to control a HMI to enable a user to input the merit order. Alternatively or additionally, the processing system may be operative to receive the merit order via a data interface. The processing system may be operative to store the merit order in the storage device 23 for repeated use, e.g., when determining a time series of setpoints that mitigate congestions expected based on a time series of (future) operating conditions. The curtailment amounts may be determined further based on a magnitude of an overload condition at a line, transformer, and/or bus (such as a bus voltage violation).

One or several setpoint(s) or other settings determined by the method may be output by the processing system 20. The processing system 20 or a distribution system control system comprising the processing system 20 may cause the setpoint(s) to be used, thereby resolving the presently existing conditions or preventing a future congestion from occurring.

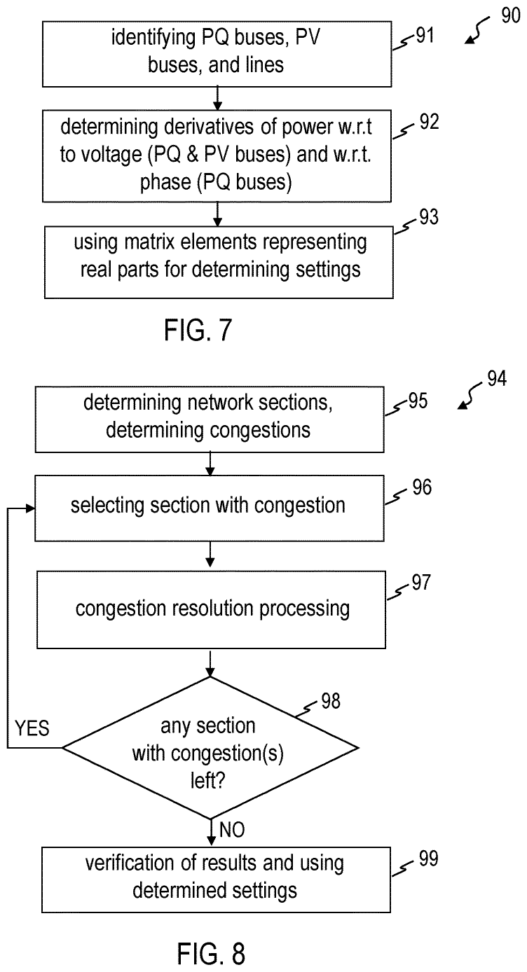

FIG. 7 is a flow chart of a process 90. The process 90 may be performed to implement process block 82 of FIG. 5. The process 90 may be performed automatically by the processing system 20 or by a distribution system control system comprising the processing system 20.

At process block 91, PV buses, PQ buses, and lines of at least a section of the power distribution grid are identified. Identifying the PV buses, PQ buses, and lines may comprise identifying the PV buses, PQ buses, and lines of a section of the power distribution grid identified by the processing system 20.

At process block 92, derivatives of power changes (which are a function of power transactions between buses) are determined with respect to voltage magnitude for both the identified PV buses and the identified PQ buses. In addition, derivatives of the power changes are determined with respect to voltage phase for the PQ buses. The powers for which the derivatives are determined may comprise both active powers (PV and PQ buses) and reactive powers (PQ buses). The derivatives may be determined in a sparse matrix formulation, rendering the determination efficient.

Processing block 92 may comprise determining derivatives of power with respect to voltage magnitude for PV and PQ buses of the section of the distribution grid to determine matrix elements of a sensitivity matrix, and multiplying a real part of the sensitivity matrix with incremental voltage changes to determine at least some of the PTDFs.

By determining the matrix elements of the PTDF matrix in sparse formulation by computing the derivatives, the processing system 20 determines the AC-PTDF matrix efficiently. The AC-PTDF matrix may be determined without performing an inversion of the sensitivity matrix. This renders the techniques disclosed herein suitable for operations where time is critical, e.g., for resolving congestions efficiently (e.g., in near real time).

At process block 93, at least the real parts of the determined AC-PTDF matrix elements (also referred to as AC-PTDFs herein) may be used to determine the settings for at least one generator and/or load connected to the respective section of the distribution grid, to resolve the congestion(s). FIG. 8 is a flow chart of a process 94. The process 94 is an iterative process. The method or processes of any one or any combination of FIG. 5, FIG. 6, or FIG. 7 may be performed in each iteration of the iterative process. The process 94 may be performed automatically by the processing system 20 or by a distribution system control system comprising the processing system 20.

At process block 95, the at least one processing circuit 30 determines network sections. The distribution system data 28 and, in particular, data defining the distribution grid topology may be used to determine network sections in a systematic manner. The determination of network sections reduces complexity of the congestion resolution processing. Thus, control actions that eliminate or at least reduce the congestion can be taken in a time-efficient manner (e.g., near real-time). While various techniques may be used to segment the distribution grid into sections for distribution resolution processing, one technique that is particularly useful is to determine radial feeder sections extending from a radial feeder and determining loop sections. The union of these two types of sections defines all sections. Congestions may be identified by performing power flow computations.

At process block 96, one of the sections having a congestion is selected.

At process block 97, congestion resolution processing is performed. The congestion resolution processing may be performed using any of the techniques described herein, e.g., with reference to FIG. 5, FIG. 6, or FIG. 7.

At process block 98, it is determined whether a section having a congestion is left. If a section having a congestion is left, the method return to process block 96. Otherwise, the method proceedings to process block 99.

At process block 99, a verification is performed (using, e.g., a further power flow computation for the determined settings from process block 97) to confirm that the congestion is indeed resolved. The processing system 20 may cause the determined settings (e.g., adjusted setpoints) to be used.

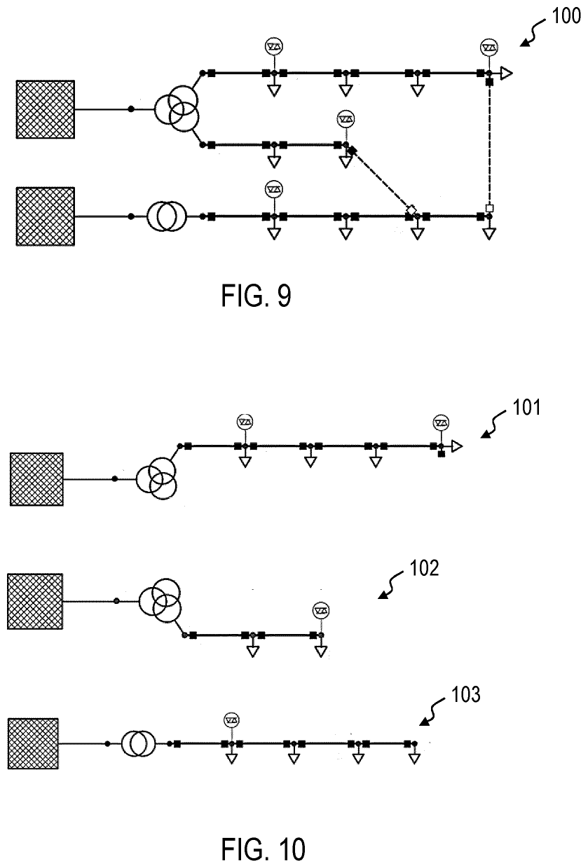

FIG. 9 shows a distribution grid 100. FIG. 10 shows sections 101, 102, 103 obtained when the distribution grid is segmented into radial feeder sections 101, 102 and one or several loop section(s) 103. The congestion resolution processing (and optionally also the congestion identification) may be performed individually for each of the sections 101, 102, 103.

In each of the processing systems, methods, and processes disclosed herein, the updated settings may be used to update any outstanding congestion(s) not only in the section in which the congestion has been resolved, but also in all other sections of the power distribution grid. A curtailment that resolves a first congestion may inherently cause a second congestion to be resolved, thereby obviating the need for separate congestion resolution processing. This updating may be performed based on the PTDFs.

In each of the processing systems, methods, and processes disclosed herein, the at least one processing circuit 30 may be operative to update the PTDFs after a curtailment. Updating the PTDFs may be done using a linear approximation of the updated active and, optionally, reactive powers, based on the respective curtailment amount. The updating may be limited to those PTDF matrix elements (e.g., AC-PTDF matrix elements) associated with buses to which generators and/or loads are connected for which adjusted settings are determined to resolve the congestion. The updated PTDF(s) may be used for updating congestion(s) yet to be resolved (as described in the preceding paragraph) and/or for performing an initial check that the congestion is indeed resolved.

In each of the processing systems, methods, and processes disclosed herein, a full power flow computation may be performed subsequently (e.g., after an initial verification based on the updated PTDFs) to confirm that all congestions in the distribution grid are resolved.

In each of the processing systems, methods, and processes disclosed herein, the congestion resolution processing may be performed for all congestions identified to exist in the same section of the distribution grid. Thereby, settings for a generator and/or load curtailment are determined that resolve all congestions in the respective section of the power distribution grid.

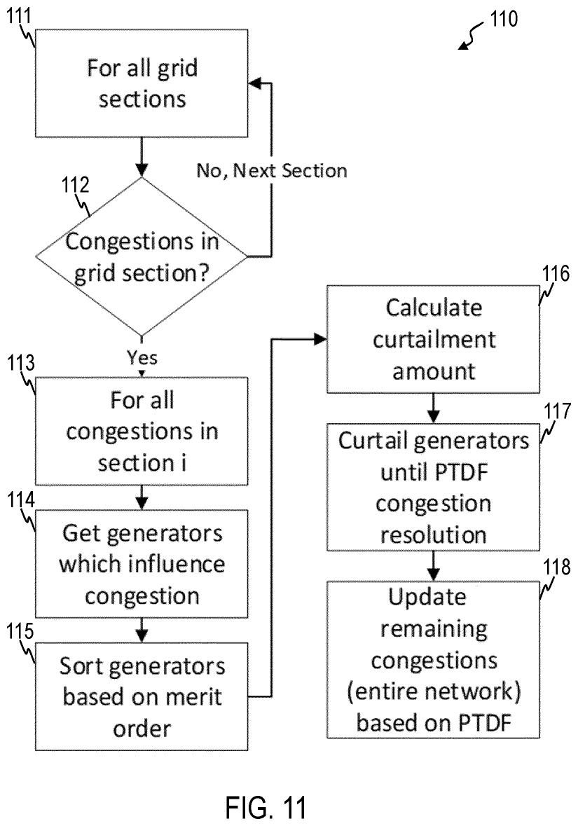

FIG. 11 is a flow chart of a method 110. The method 110 may be performed automatically by the processing system 20. The at least one processing circuit 30 may determine sections of the power distribution grid, thereby segmenting the power distribution grid, as described with reference to FIG. 8, FIG. 9, and FIG. 10.

At process blocks 111, 112, the at least one processing circuit 30 loops through sections until a section is identified in which there is at least one congestion. This may comprise performing a power flow computation for the respective section and comparing the conditions obtained thereby to the distribution system data 28 to identify congestion(s).

At process block 113, an inner iteration is started over all congestions in the respective section.

At process block 114, all generators and/or loads in the section of the power distribution grid are determined which influence the congestion. This is done in a sensitivity-based manner, using the PTDFs to determine which generators and/or loads influence the congestion. A relevance check (such as a threshold comparison of a magnitude of a PTDF matrix element) may be performed to identify those generators and/or loads that influence the congestion to a degree that is considered relevant (according to the relevance check).

At process block 115, the generators and/or loads identified at process block 114 may be sorted based on the merit order. The merit order may be such renewable energy resources have a position in the merit order which makes it unlikely for the renewable energy resource(s) to be curtailed, if curtailment of any conventional, non-renewable energy resource has the potential to resolve the congestion.

At process block 116, a curtailment amount may be determined by the at least one processing circuit 30. The curtailment amount may be a fixed incremental amount (in which case several fixed incremental steps may need to be taken in order for the curtailment to be sufficient to resolve the congestion). The curtailment amount may be an amount computed based on the magnitude of the overload condition.

At process block 117, generators and/or loads are curtailed. This may comprise determining settings for generators and/or loads identified at process block 114, in a sequence that depends on the merit order (process block 115), until the congestion is resolved.

At process block 118, the remaining (i.e., still unresolved) congestions are updated based on the curtailment at process block 117. This updating may be performed based on the PTDFs (which is time-efficient) and/or by performing a further power flow computation (which is more accurate). The updating may be performed in a variable manner based on the PTDFs or a further power flow computation, depending on whether time is of essence. For illustration, for a congestion predicted to occur in a prognostic time interval that is sufficiently far in the future in order for a further power flow computation to be performed, the further power flow computation can be performed. Otherwise, updating based on the PTDFs may be used. The determination on whether the updating is based on the PTDFs or a further power flow computation may also be dependent on which curtailment technique is used (such as a greedy curtailment scheme, a ripple control curtailment scheme, or a proportional curtailment scheme).

The processing system 20 may be operative to determine the curtailment amounts according to various techniques. The processing system 20 may be operative such that the at least one processing circuit 30 control a HMI to enables a selection of which scheme for determining the curtailment amounts is to be selected. The techniques of determining the curtailment amounts described below are all sensitivity-based (by being based on the PTDFs) and based on the merit order, and may be dependent on additional factors. For illustration, a random factor may be used to determine which one of two generators having the same merit order is to be curtailed, when both generators are suitable for resolving a congestion. The random factor may be determined using a pseudorandom number generator or a quantum random number generator, for example. By using the random generator, an unbiased decision can be taken.

The curtailment techniques may comprise techniques which distribute the curtailment among a number of generators and/or loads, even when a stronger curtailment of fewer generators would also be sufficient to resolve the congestion. The curtailment techniques may comprise techniques that minimize the number of generators and/or loads for which new setpoints are to be determined.

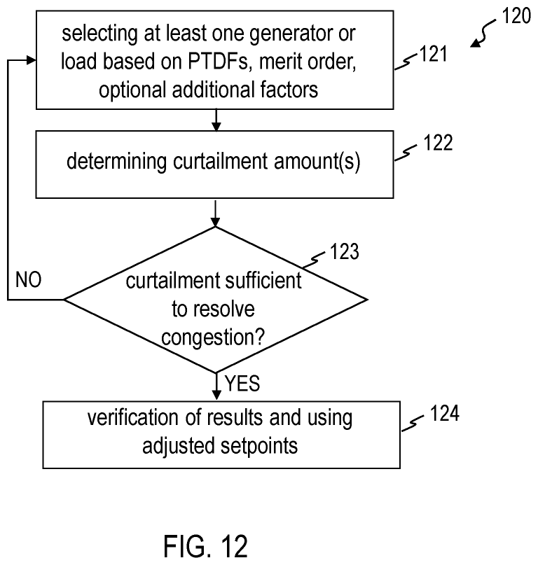

FIG. 12 is a flowchart of a method 120 according to an embodiment. The method 120 may be performed automatically by the processing system 20. The method 120 may be performed for each section of a power distribution grid in which a congestion is identified.

At process block 121, at least one generator or load is selected based at least on the PTDFs and the merit order. The generator or load is connected to a bus for which the PTDF matrix element is non-zero (and may have a magnitude greater than a threshold magnitude that is applied to identify relevant generators and/or loads), with the PTDF matrix element linking the bus to a congested line. The at least one generator or load may be selected based on additional factors, such as a random factor. The random factor may be used to select a generator or load in an unbiased manner, from among generators and/or loads that are suitable to address the congestion and that have the same merit order.

At process block 122, curtailment amount(s) are determined for the generator or load. The determination of the curtailment amount(s) may be performed according to a technique that can be pre-determined, determined from a set of available techniques by the processing system 20, or can be selected by a DSO via a HMI controlled by the processing system 20 to enable the selection. The technique may be selected from a greedy technique, a proportional technique, a ripple control technique.

At process block 123, it is determined whether the curtailments of generators and loads already determined resolve the congestion. If not, the method returns to process block 121. Otherwise, the method proceeds to process block 124.

At process block 124, a verification is performed (using, e.g., a further power flow computation for the determined settings from process block 122) to confirm that the congestion is indeed resolved. The processing system 20 may cause the determined settings (e.g., adjusted setpoints) to be used.

Thus, the processing systems and processing methods and the distribution system control systems and method according to embodiments may be operative to divide the distribution grid into individual loops and feeders that can be resolved essentially independently), determine the generators and/or loads that impact the congested lines that occur in each of these sections, and then curtail the generators based on a merit order. A pseudocode for the operation is provided below:

| | Input: network, input-time-series, If-results, congestions, prev-corrective-actions | | | |
|---|---|---|---|---|
| | Output: redispatched-time-series | | | |
| 1 | redispatched-time-series ← emptyTimeSeries( ) | | | |
| 2 | radial-feeders ← getRadialFeeders(network) | | | |
| 3 | loops ← getLoops(network) | | | |
| 4 | all-sections ← radial-feeders + loops | | | |
| 5 | ptdf ← loadflow.getPTDF( ) | | | |
| 6 | foreach i ∈ all-sections do | | | |
| 7 | \| | foreach line ∈ congestions(i) do | | |
| 8 | \| | \| | influencing-elements ← getInfluencingElements(line, i, ptdf) | |
| 9 | \| | \| | if influencing-elements == ∅ then | |
| 10 | \| | \| | \| | break |

| | | | |
|---|---|---|---|
| 11 | \| | \| | end |
| 12 | \| | \| | sorted-elements ← meritOrderSort(influencing-elements) |
| 13 | \| | \| | redispatch-actions ← calculateRedispatchAmount(line, sorted-elements, ptdf) |
| 14 | \| | \| | congestions ← updateAllCongestions(redispatch-actions, ptdf) |
| 15 | \| | \| | redispatched-time-series.merge(redispatch-actions) |

| | | |
|---|---|---|
| 16 | \| | end |

| | |
|---|---|
| 17 | end |

The inputs to the technique are the network of the distribution system (which may comprise the Jacobian, the network topology matrix, the admittance matrix, and optionally additional data required to perform congestion identification and/or congestion resolution processing), the profiles for all loads and generators as well as an planned switching actions or outages (input_time_series), results from the power flow (lf_results) that were used to determine the congested lines (congestions), and any corrective actions that were calculated by other congestion resolution methods that were run previously (prev_corrective_actions, e.g., topology changes). Each of the loads and generators may be assigned a merit order (which may optionally be such that renewable energy resources are less likely to be curtailed than conventional generators); in the absence of a user-defined merit order, all loads and generators are treated equally. The outputs of the technique are the redispatch actions (redispatched_time_series).

The first step in the technique is to break the grid into radial parts (radial_feeders) and loops. Radial feeders can be radial sections extending off a loop. The idea behind this is that if there are generation-based congestions in the radial feeders; they can only be dealt with internally within the feeder. The feeders are sorted by decreasing distance to the head of the feeder (i.e., furthest bus from the feeder head is first in the list). The reason for this is that resolving an upstream congestion may in-turn resolve downstream congestions. The sets of radial parts and loops are combined (all_sections) into an ordered set with the radial feeders appearing first. This is because, if a radial feeder is hanging off a ring/loop that resolving congestions there can in-turn resolve the congestions in the loop Next, the Power Transfer Distribution Factor (PTDF) matrix is retrieved.

An important aspect of processing and control techniques according to embodiments is the PTDF matrix which indicates the incremental change in real power that occurs on transmission lines due to real power transfers between two regions that can be defined by areas, zones, super areas, single buses, injection groups or the system slack. In embodiments, the PTDFs can specify interdependencies between buses and lines, which can be estimated by the PTDF matrix. The matrix dimensions are calculated as follows: rows=number of lines, columns=2*number of PQ buses+1*number of PV buses. The PTDF matrix can be calculated using the Jacobian and the admittance matrix that are used in the non-linear power flow calculations. In short, the PTDF matrix provides information on the sensitivity of how much a change in a bus's infeed impacts a power line.

As mentioned above determining the PTDFs may comprise determining a sensitivity matrix, wherein determining the sensitivity matrix comprises determining derivatives of power with respect to voltage magnitude for PV and PQ buses of the section of the distribution grid to determine matrix elements of a sensitivity matrix. Determining the PTDF matrix may then comprise multiplying a real part (and if desired, also a reactive part) of the sensitivity matrix with incremental voltage changes to determine at least some of the PTDFs. The PTDF value coupled with the network topology is used to determine which elements (loads/generators) can influence a congestion (influencing_elements).

As mentioned above, various curtailment techniques can be used. The first difference between the curtailment techniques is how their merit order values sorts the influencing_elements. The greedy redispatch and ripple control technique sort them in a unique manner, based on a linear combination of merit order, PTDF value, and a random factor to ensure that the same generators are not curtailed every time. The proportional redispatch technique sorts the elements based on their user-defined values which may not be unique. All elements of the same merit order are treated as equal.

After the elements have been sorted their new settings (e.g., setpoints) can be calculated starting with the first element(s) in the list. The simplest scenario in this case is a ripple control. The ripple control moves in predefined steps to resolve the congestion (e.g., power output reduction of 10%, then 30%, then 50%, etc.). In this example, the highest merit order load/generator would have its power setpoint reduced by 10%, then if this is insufficient to resolve the congestion 30% until the congestion has been resolved. If it is not possible to resolve the congestion using this element the next highest merit order element has its power setpoint reduced in a similar manner.

Instead of moving in predefined steps, the greedy curtailment technique uses the PTDF sensitivities to calculate exactly what the new setpoint should be to resolve the congestion. If the setpoint cannot be achieved with the current highest merit order load/generator the unit has its power reduced to its min allowable value before moving to the next element until the congestion is resolved. The following formulae are used to calculate the new setpoint.

$$reduction\_amount = ( congestion\_amount + ϵ ) * line\_power \qquad ( 1 )$$

$$curtailment\_amount = reduction\_amount / ptdf\_value \qquad ( 2 )$$

$$new\_setpoint = \{ \begin{matrix}( old\_setpoint - curtailment\_amount ) & ( if new\_setpoint > min\_allowable \\ min\_allowable \_setpoint & else\end{matrix} \qquad ( 3 )$$

The at least one processing circuit 30 is operative to compute, based on Equation (1), the amount that the power flowing through the line (line_power) needs to be reduced to resolve the congestion where ϵ is a tolerance to account for potential inaccuracies in the PTDF value. The at least one processing circuit 30 is operative to compute, based on Equation (2), the amount that the current element needs to be curtailed to get to that desired power reduction. The at least one processing circuit 30 is operative to compute, based on Equation (3), the new setpoint based on the current setpoint and the curtailment amount. If this is lower than the minimum allowable value for the generator, its capped at that amount.

A pseudocode for the greedy redispatch technique is provided below:

| | Input: line, sorted-elements, ptdf | | |
|---|---|---|---|
| | Output: redispatched-time-series | | |
| 1 | line-power = line.getPower( ) | | |
| 2 | congestion-amount = line.getCongestionAmount( ) | | |
| 3 | foreach i ∈ sorted-elements do | | |
| 4 | \| | if congestion-amount ≤ 0 then | |
| 5 | \| | \| | return redispatch-actions |
| 6 | \| | end | |
| 7 | \| | injection = i.getInjectionAmount( ) | |
| 8 | \| | reduction-amount = ((congestion-amount/100)+∈)* line-power | |
| 9 | \| | ptdf-val = ptdf[line, i] | |
| 10 | \| | curtailment-amount = reduction-amount/ptdf-val | |
| 11 | \| | if curtailment-amount > injection then | |
| 12 | \| | \| | new-setpoint = 0 |
| 13 | \| | \| | curtailment-amount = injection |
| 14 | \| | end | |
| 15 | \| | else | |
| 16 | \| | \| | new-setpoint = injection − curtailment-amount |

| | | |
|---|---|---|
| 17 | \| | end |
| 18 | \| | congestion-amount = updateCongestion(line, curtailment-amount) |
| 19 | \| | redispatch-actions.merge(i, new-setpoint) |

| | |
|---|---|
| 20 | end |

Conceptually the ripple control redispatch technique is similar to the greedy redispatch with the exception that instead of jumping to the predicted resolution amount, steps of a predefined progression (i.e., curtailment by fixed, predefined increments or decrements) are taken. Instead of curtailing a single generator the proportional redispatch technique distributes the necessary curtailment amount among all the generators of the same user-defined merit order. To do this, the original congestion amount is divided by all the elements of the same merit order which they are then responsible for resolving in the same manner as the greedy redispatch. The at least one processing circuit 30 may be operative to perform this split in accordance with Equation (4):

$$congestion\_amount \_by {\_element}_{j} = \frac{{ptdf}_{j}}{{\sum }_{j}^{i} {ptdf}_{j}} * congestion\_amount ∀ j ∈ i \qquad ( 4 )$$

Pseudocode for the proportional redispatch technique is provided below:

| | Input: line, sorted-elements, ptdf | | | |
|---|---|---|---|---|
| | Output: redispatched-time-series | | | |
| 1 | line-power = line.getPower( ) | | | |
| 2 | congestion-amount = line.getCongestionAmount( ) | | | |
| 3 | foreach i ∈ sorted-elements do | | | |
| 4 | \| | if congestion-amount ≤ 0 then | | |
| 5 | \| | \| | return redispatch-actions | |
| 6 | \| | end | | |
| 7 | \| | congestion-amount-by-element = divideCongestions(ptdf) | | |
| 8 | \| | foreach j ∈ i do | | |
| 9 | \| | \| | injection = j.getInjectionAmount( ) | |
| 10 | \| | \| | reduction-amount = ((congestion-amount-by-element[j]/100)+∈)* line-power | |
| 11 | \| | \| | ptdf-val = ptdf[line, j] | |
| 12 | \| | \| | curtailment-amount = reduction-amount/ptdf-val | |
| 13 | \| | \| | if curtailment-amount > injection then | |
| 14 | \| | \| | \| | new-setpoint = 0 |
| 15 | \| | \| | \| | curtailment-amount = injection |
| 16 | \| | \| | end | |
| 17 | \| | \| | else | |
| 18 | \| | \| | \| | new-setpoint = injection − curtailment-amount |

| | | | |
|---|---|---|---|
| 19 | \| | \| | end |
| 20 | \| | \| | congestion-amount = updateCongestion(line, curtailment-amount) |
| 21 | \| | \| | redispatch-actions.merge(i, new-setpoint) |

| | | |
|---|---|---|
| 22 | \| | end |

| | |
|---|---|
| 23 | end |

Once the new setpoints have been computed the reduction amount is applied to all relevant congestions as changing the setpoint of one element may help resolve congestions in several places. This can be done either using the PTDFs or by running a power flow with the new setpoints.

The output of the techniques are the new setpoints for the loads/generators in the network to resolve the congestions. The processing system 20 or a control system coupled to or comprising the processing system 20 may control the distribution system to apply the new setpoints.

The techniques are flexible and designed to match realistic ways to resolve congestions and unbiased in the way that the congestions are resolved. Thus, the techniques fulfill the following objectives:
Secure operation of the power grid
The curtailment is efficient, non-discriminatory, and transparent
The curtailment lends itself to alignment with environmental goals by prioritizing the in-feed of renewable energy (as may be defined by the merit order, for example)
The curtailment has low complexity of use and returns results quickly, e.g., in near real-time.

The curtailment technique that is respectively used may be dependent, on, e.g., DSO preferences, technical capabilities of the distribution system, and/or legal requirements.

This heuristic-based curtailment can be done in the various ways described in detail herein, depending on, e.g., user preferences: a pure greedy curtailment in which the most impactful generator is completely curtailed before moving on to subsequent generators, a ripple control heuristic in which each generator is curtailed in discrete steps, and a proportional heuristic in which all generators with the same priority are curtailed proportionally according to their sensitivity values. This process is performed iteratively until all congestions in the network have been resolved.

These three techniques were chosen to account for different regulatory, preferential, and technical-based constraints. The greedy curtailment begins with the most impactful generator; therefore, it typically results in the lowest overall curtailment amount. This comes at the cost that, if congestions typically occur in the same location, the most efficient generator to resolve it tends to be the same. Repeatedly curtailing the same generator may make the solution seem unfair. Opposite of this is the proportional redispatch, which curtails all the generators which can impact a congestion proportionally based on their ability to resolve the congestion. This distributed the total curtailment over all the generators which can be perceived as a ‘fairer’ solution but will result in higher overall curtailment a less efficient generators are being curtailed to resolve each congestion. The ripple redispatch method overcomes the challenge that sometimes it is not possible to curtail generators exactly, rather they are curtailed in set steps which is exactly what the ripple control algorithm does.

Thus, the processing system 20 may be operative such that the storage system 23 stores instructions for performing any one of a variety of different techniques of determining curtailment amounts (such as greedy, proportional, ripple control). The at least one processing circuit 30 may be operative to perform the congestion resolution processing, determining the curtailment amounts in accordance with one of these techniques (based on, e.g., user preferences and/or regulatory requirements and/or technical capabilities of the generators and/or loads of the distribution system). All of the techniques are sensitivity-based approaches. They all begin by identifying which loads and generators can influence a specific congestion. These influencing elements can be sorted based on an order that can depend on the merit order but is otherwise specific to the respective curtailment amount determination technique (such as greedy, ripple control, proportional). The elements are then given new setpoints in their order based on their sensitivity values (PTDFs) until the congestion has been resolved. A group of elements with the same priority can be moved to their minimum allowable value before moving on to the next sorted item. Once a generator/load is given a new setpoint, all congestions that are impacted by this change are updated. Once the current congestion has been resolved the technique iterates through the remainder of the congestions and the method to resolve a specific congestion is begun again.

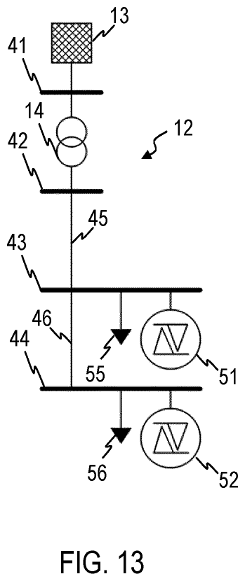

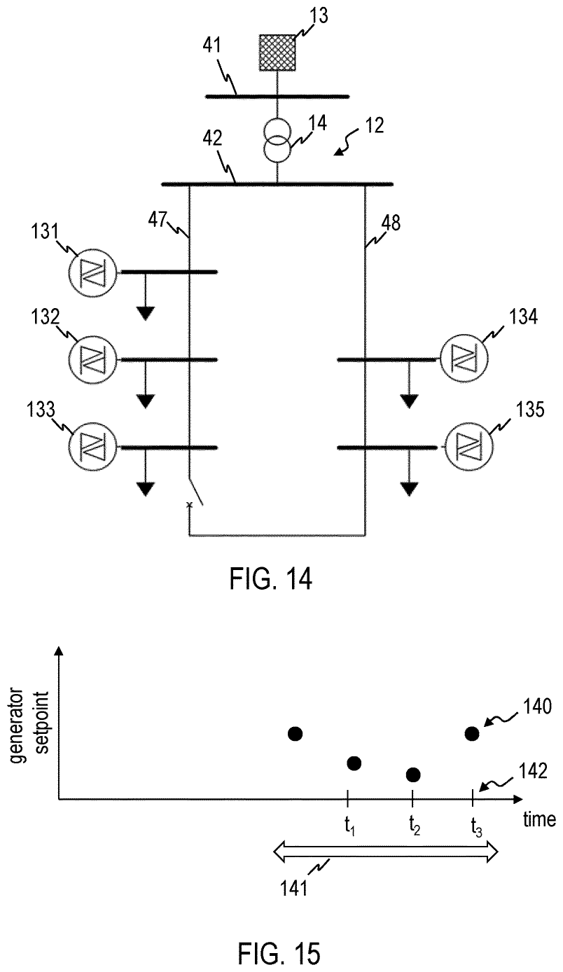

FIG. 13 shows a distribution system 12 in which generators 51, 52 can be controlled to resolve congestion(s) at lines 45, 46. FIG. 14 illustrates a distribution system in which generators 131, 132, 133, 134, 135 can be controlled to resolve congestions at lines 47, 48. The results of the congestion resolution processing will generally be dependent on the specific implementation of determining the curtailment amounts and the merit order(s) assigned to generators and/or loads, as will be explained with reference to FIGS. 13 and 14.

Referring to the power distribution system 12 of FIG. 13, it will be assumed that all AC-PTDFs are non-zero. I.e., curtailment of generator 51 is suitable to resolve a congestion at both lines 45, 46, and curtailment of generator 52 is suitable to resolve a congestion at both lines 45, 46. When there is an overload at line 45 and both generators 51, 52 have different merit order values, in a greedy scheme, only the one of the generators 51, 52 that is to be curtailed first (according to the merit order) will be curtailed, provided this is sufficient to resolve the congestion. If there is a congestion at both lines 45, 46, it is possible for the one of the generators having lower merit order to be curtailed, if the combination of PTDFs and merit order shows that this is the more suitable operation to resolve both congestions.

Referring to the power distribution system of FIG. 14, it will be assumed that the merit order specifies that generators 131-133 are to be curtailed first (e.g., by assigning them merit order ‘1’), and that generators 134, 135 are to be curtailed only with lower likelihood (e.g., by assigning them merit order ‘2’). It is further assumed that there is an overload condition at both lines 47, 48, and that the PTDFs indicate that generators 131-133 can all influence the overload at both line 47 and at line 48. In a greedy scheme, one or several of the generators 131-133 are curtailed. The generator(s) depend on the PTDFs and, optionally, a random factor (as well as the merit order, which is the same for generators 131-133). For ripple control, one of the generators 131-133 may be curtailed down to 0 MW power, and another one of the generators 131-133 may be curtailed if required to resolve both congestions. For a proportional technique, all of generators 131-133 may be curtailed, with the new setpoints being non-zero for all of the generators.

An important effect attained by the techniques disclosed herein is that the processing and control systems and methods disclosed herein may be operative to perform the processing to resolve presently existing or expected future congestions not only for a single point in time, but for several points in time. Thereby, a series of control actions may be determined (e.g., in the form of a timeseries of setpoints) that resolves the congestions expected according to a series of operating conditions (e.g., generator and load powers). To this end, the processing described with reference to FIGS. 1 to 14 may be performed repeatedly for the various operating conditions expected for various points in time.

FIG. 15 illustrates this operation: The processing system 20 may be operative to perform the congestion identification and congestion resolution processing (using any of the techniques disclosed herein) for various operating conditions at various times 142 in a time interval 141. The time interval 141 may be a time interval in the future. As a result, the processing system 20 is operative to determine a series of setpoints 140 for generators and/or loads. While this is illustrated only for one generator, corresponding setpoints may be determined for all generators and all adjustable loads for the various times 142.

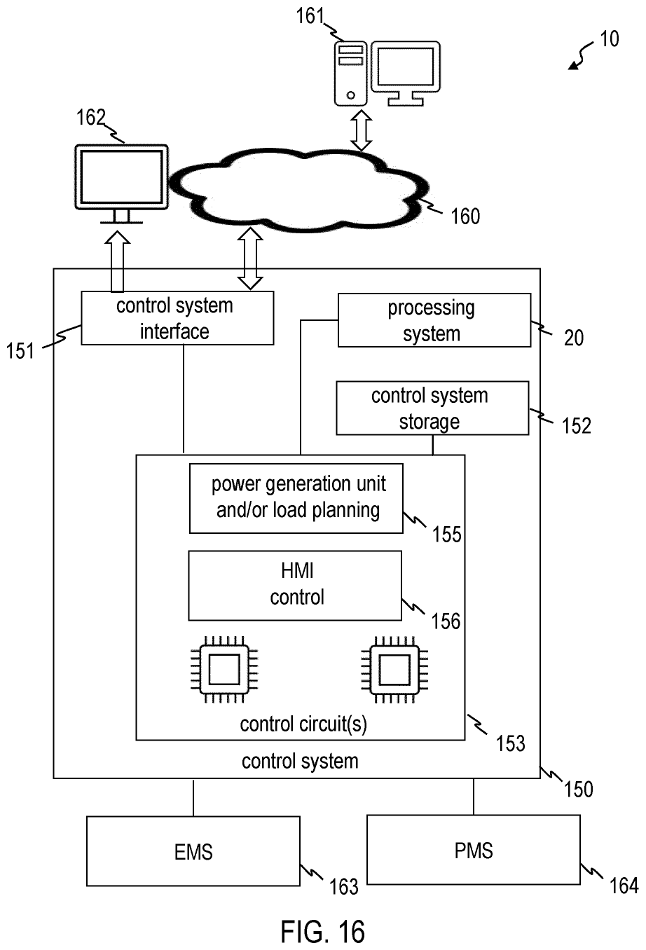

FIG. 16 is a block diagram of a system 10 according to an embodiment. The system 10 comprises the processing system 20 which may be operative according to any one of the embodiments disclosed herein.

The system 10 comprises at least one server 161 operative to provide forecast information which has the potential of affecting power generation and/or load power. The forecast information may comprise whether forecast information, in particular if the power grid has a renewables penetration. The forecast information may comprise load forecast information which may be based on historical data. The control system 150 may be operative to store the forecast information or information derived therefrom in a control system storage 152. The control system storage 152 may also store information on setpoints for generators and/or loads, used in the congestion resolution processing performed by the processing system 20.

The processing system 20 and/or a control system 150 of the system 10 may be communicatively coupled with the at least one server 161 over a dedicated network or a wide area network 160 or the internet. The processing system 20 and/or the control system 150 may be operative to retrieve the forecast information from the at least one server 161 and to use the forecast information in combination with the at least one response parameter determined by the processing system 20 for identifying congestions.

The system 10 may comprise a human machine interface (HMI) 162 which may be communicatively coupled with the processing system 20 and/or the control system 150. The processing system 20 and/or the control system 150 may be operative to cause setpoints to be output via the HMI 162. For illustration, the processing system 20 may cause the setpoints that resolve congestions to be output via the HMI 162 for further use. Alternatively or additionally, the processing system 20 and/or the control system 150 may cause a confirmation to be output via the HMI 162, indicating that control actions have been taken to resolve a congestion.

The system 10 comprises the control system 150. The processing system 20 may be operative to provide the output of the congestion resolution processing (which may comprise one or several setpoints for at least one generator and/or at least one load of the power distribution system) to the control system 150.

The control system 150 may comprise at least one control circuit 153. The at least one control circuit 153 may comprise any one or any combination of integrated circuits, integrated semiconductor circuits, processors, controllers, application specific integrated circuits (ASICs), field programmable gate arrays (FPGAs), circuit(s) including quantum bits (qubits) and/or quantum gates, without being limited thereto.

The at least one control circuit 153 may be operative to effect generator and/or load curtailment to be performed based on and in accordance with the congestion resolution processing performed by the processing system.

The at least one control circuit 153 may be operative to perform a power generator unit and/or load planning 155. The at least one control circuit 153 may be operative to adjust, for example, power generator unit commitment based on a result of the congestion resolution processing. The at least one control circuit 153 may be operative to perform a control action acting on, e.g., at least on the power generation units, at least one rotating energy storage system, and/or at least one disconnector or circuit breaker in the distribution system. The control action may be selectively taken depending on the result of the congestion resolution processing. The control action may be selected depending on the result of the congestion resolution processing.

When the distribution system has renewables penetration, the at least one control circuit 153 may be operative to determine adjusted settings for an energy management system (EMS) 163 and/or power management system (PMS) 164. The system 10 may comprise the EMS 163 and/or the PMS 164. The control system 150 may be operative to cause the adjusted settings to be used by the EMS 163 and/or the PMS 164 in accordance with the congestion resolution processing.

The at least one control circuit 153 may be operative to perform an HMI control 156. The at least one control circuit 153 may cause an alarm, warning, or other information that is based on the congestion resolution processing to be output via the HMI 162.

Various effects and advantages are attained by the processing system, processing method, control system, and control method according to embodiments. The systems and methods can determine which generators and/or loads are to be curtailed to resolve a congestion, thereby assisting in distribution system control. The systems and methods are operative to determine the generators and/or loads to be curtailed in a fair and unbiased manner, based on objective criteria. Curtailment of loads and generators that is based on human operator experience may result in suboptimal solutions and a large waste of renewable energy, which goes against clean-energy policies and may also cause the curtailment to be perceived as being unfair. The processing system and method of embodiments provides a congestion resolution based on objective criteria, using the sensitivity information provided by a PTDF matrix. The merit order- and sensitivity-based redispatch performed by the processing system 20 automatically resolves network congestions by identifying which loads and generators impact the congestions and curtails them heuristically in a merit-based order. This can be done in both a real-time- or forecast-based manner, providing a technique operative for predicting and resolving a potential problem before it occurs. If multiple generators are assigned the same curtailment merit order, they can be curtailed heuristically based on their ability to resolve the congestions and the desired curtailment scenario.

While embodiments have been described in detail with reference to the drawings, various modifications may be implemented in other embodiments. For illustration rather than limitation:
The described processing or control systems or methods can also be combined with grid internal congestion management methods that control switches or transformer tap positions. For example, the grid internal measures can be applied, then the sensitivities are calculated based on the current topology and then heuristic redispatch is performed. In this manner, a more comprehensive solution for mitigating overloads as well as voltage related issues in the distribution/sub-transmission grids.
The described processing or control systems or methods can use heuristic redispatch to determine a good starting point for an optimization-based congestion resolution method.

Embodiments may be used in association with a power grid having renewables penetration, such as power grid comprising renewable energy systems (such as DERs), without being limited thereto.

This description and the accompanying drawings that illustrate aspects and embodiments of the present invention should not be taken as limiting—the claims defining the protected invention. In other words, while the invention has been illustrated and described in detail in the drawings and foregoing description, such illustration and description are to be considered illustrative and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figures individually although they may not have been described in the afore or following description. Also, single alternatives of the embodiments described in the Figures and the description and single alternatives of features thereof can be disclaimed from the subject matter of the invention or from disclosed subject matter. The disclosure comprises subject matter consisting of the features defined in the claims or the embodiments as well as subject matter comprising said features.

The term “comprising” does not exclude other elements or process blocks, and the indefinite article “a” or “an” does not exclude a plurality. A single unit or process block may fulfil the functions of several features recited in the claims. The mere fact that certain measures are recited in mutually different dependent claims does not indicate that a combination of these measures cannot be used to advantage. Components described as coupled or connected may be electrically or mechanically directly coupled, or they may be indirectly coupled via one or more intermediate components. Any reference signs in the claims should not be construed as limiting the scope.

A machine-readable instruction code may be stored/distributed on a suitable medium, such as an optical storage medium or a solid-state medium supplied together with or as part of other hardware, but may also be distributed in other forms, such as via a wide area network or other wired or wireless telecommunication systems. Furthermore, a machine-readable instruction code can also be a data structure product or a signal for embodying a specific method such as the method according to embodiments.

1. A processing system, comprising:
at least one processing circuit operative to
perform a congestion identification to identify a congestion in at least a section of a distribution grid of an electric power grid;
perform congestion resolution processing to mitigate or eliminate the congestion, the congestion resolution processing comprising a determination of at least one element that is to be controlled to mitigate or eliminate the identified congestion, the at least one element comprising at least one generator and/or at least one load, the at least one processing circuit being operative to determine the at least one element based on power transfer distribution factors (PTDFs) determined for at least the section of the power grid; and
generate output that is provided via at least one interface of the processing system based on the congestion resolution processing.

2. The processing system of claim 1, wherein the congestion resolution processing comprises a determination of an updated setting for each element of the at least one element based on the PTDFs, and the at least one processing circuit is operative to generate the output based on the updated setting.

3. The processing system of claim 2, wherein the at least one processing circuit is operative such that the updated setting comprises a curtailment of the determined at least one generator and/or at least one load.

4. The processing system of claim 3, wherein the at least one processing circuit is operative to determine the curtailment based on the PTDFs.

5. The processing system of claim 3, wherein the at least one processing circuit is operative to determine the curtailment based on a number of elements to be controlled to mitigate or eliminate the identified congestion.

6. The processing system of claim 3, wherein the at least one processing circuit is operative to determine the curtailment independently of a number of elements to be controlled to mitigate or eliminate the identified congestion.

7. The processing system of claim 1, wherein the PTDFs are complex-valued.

8. The processing system of claim 7, wherein the at least one processing circuit is operative to perform the congestion resolution processing one or both of based on a real part of the PTDFs, or independently of an imaginary part of the PTDFs.

9.-10. (canceled)

11. The processing system of claim 1, wherein the at least one processing circuit is operative to perform a PTDF determination to determine the PTDFs, wherein the PTDF determination comprises a power flow computation.

12. The processing system of claim 11, wherein the at least one processing circuit is operative to apply scaling factors to admittances used in the power flow computation.

13. The processing system of claim 1, further comprising a human machine interface (HMI), wherein the processing system is operative to enable the user to specify a merit order relating to loads and/or generators of the distribution grid, wherein the at least one processing circuit is operative to perform the congestion resolution processing based on the merit order.

14. (canceled)

15. The processing system of claim 13, wherein the congestion resolution processing comprises a determination of an updated setting for each element of the at least one element based on the PTDFs, and the at least one processing circuit is operative to generate the output based on the updated setting, and wherein the at least one processing circuit is operative to determine the updated setting based on the merit order.

16. The processing system of claim 13, wherein the at least one processing circuit is operative to perform a ranking of generators and/or loads of the section based on the PTDFs and the merit order, and to perform the congestion resolution processing based on the ranking.

17. The processing system of claim 1, wherein the at least one processing circuit is operative to automatically determine a plurality of sections of the distribution grid based on a distribution grid topology, and to perform the congestion identification and the congestion resolution processing for each section of the plurality of sections.

18. The processing system of claim 17, wherein the at least one processing circuit is operative to perform the congestion identification and the congestion resolution processing for the plurality of sections independently for each of the plurality of sections.

19. The processing system of claim 17, wherein the at least one processing circuit is operative to identify, based on the distribution grid topology, radial feeder sections and loop sections, and wherein the at least one processing circuit is operative to determine the plurality of sections as a union of the radial feeder sections and the loop sections.

20. The processing system of claim 1, wherein the at least one processing circuit is operative to perform a verification to confirm that the congestion resolution processing mitigates or eliminates the identified congestion before generating the output.

21. The processing system of claim 20, wherein the verification comprises one or both of updating the PTDFs based on the congestion resolution processing, or performing a further power flow computation.

22.-23. (canceled)

24. The processing system of claim 1, wherein the output comprises a command operative to adjust setpoints of the determined at least one generator and/or at least one load.

25.-27. (canceled)

28. A processing method, comprising:
performing, by at least one processing circuit, a congestion identification to identify a congestion in a section of a distribution grid of an electric power grid;
performing, by the at least one processing circuit, a congestion resolution to mitigate or eliminate the congestion, the congestion resolution processing comprising a determination of at least one element that is to be controlled to mitigate or eliminate the identified congestion, the at least one element comprising at least one generator and/or at least one load, the at least one processing circuit being operative to determine the at least one element based on power transfer distribution factors (PTDFs) determined for at least the section of the power grid; and
generating, by the at least one processing circuit, output that is provided via at least one interface of the processing system based on the congestion resolution processing.

29. (canceled)
